(19) United States
(12) Patent Application Publication
(10) Pub. No.: US 2025/0235834 A1
(43) Pub. Date: Jul. 24, 2025

(54) FLOW PATH STRUCTURE, FLOW PATH STRUCTURE UNIT, AND METHOD FOR PRODUCING LIPID PARTICLE

(71) Applicant: Kabushiki Kaisha Toshiba, Tokyo (JP)

(72) Inventors: Mitsuaki KATO, Kawasaki Kanagawa (JP); Masato AKITA, Kawasaki Kanagawa (JP); Mitsuko ISHIHARA, Setagaya Tokyo (JP)

(21) Appl. No.: 19/016,572

(22) Filed: Jan. 10, 2025

(30) Foreign Application Priority Data
Jan. 22, 2024 (JP) 2024-007315

(51) Int. Cl. B01F 25/432; B01F 25/10; B01F 25/433; B01F 33/30; B01F 101/22

(52) U.S. Cl. CPC B01F 25/4323; B01F 25/10; B01F 25/4331; B01F 25/4337; B01F 33/3045; B01F 2101/22

(57) ABSTRACT

A flow path structure according to an embodiment includes three groups of flow paths connected by branch and merging portions. The first group connects to the second group via a branch portion, and the second group connects to the third group via a merging portion. The branch portion has openings on both the first and second group sides, while the merging portion has openings on both the second and third group sides. If the first group has N flow paths and the second group has M flow paths (where M is N or more), the total opening area of the second group's branch openings is at most M/N times that of the first group's branch openings. Additionally, at least one merging opening in the second group is equal to or smaller than at least one merging opening in the third group.

### CROSS-REFERENCE TO RELATED APPLICATION

This application is based upon and claims the benefit of priority from Japanese Patent Application No. 2024-007315, filed Jan. 22, 2024, the entire contents of which are incorporated herein by reference.

### FIELD

Embodiments of the present invention relate generally to a flow path structure, a flow path structure unit, and a method for producing a lipid particle.

### BACKGROUND

There are methods that use flow paths to mix, stir, and dilute various liquids. At this time, mixing efficiency can be improved by generating a vortex in the flow path. However, when a flow is generated in the direction opposite to the direction of the main flow in the flow path, this may instead cause a decrease in mixing efficiency and uniformity after mixing.

### DESCRIPTION OF THE DRAWINGS

FIG. 1 is a schematic view showing an example of a flow path structure according to a first embodiment.

FIG. 2 is a schematic view showing an example of the flow path structure according to the first embodiment.

FIG. 3 is a perspective view of the flow path structure according to the first embodiment.

FIG. 4 is a cross-sectional view of a merging portion perpendicular to a second merging opening.

FIG. 5 is a schematic view of a cross section along a main flow direction of a second flow path and a third flow path.

FIG. 6 is a schematic view showing an example of the flow path structure according to the first embodiment.

FIG. 7 is a view showing that a member for the top surface of the flow path structure can be made into a single flat plate-like member.

FIG. 8 is a perspective view of the flow path structure. FIG. 8 is a view showing some vortices that may be generated at a merging portion and a branch portion.

FIG. 9 is an example of a schematic view of a flow path structure in a first modification.

FIG. 10 is a schematic view of a cross section along the main flow direction of a flow path structure in a second modification.

FIG. 11 is a schematic view of a cross section along the main flow direction of a flow path structure in a third modification.

FIG. 12 is a schematic view showing an example of a flow path structure in a fourth modification.

FIG. 13 is a schematic view showing an example of a flow path structure in a fifth modification.

FIG. 14 is a schematic view showing an example of a flow path structure in a sixth modification.

FIG. 15 is a schematic view showing an example of a flow path structure in a seventh modification.

FIG. 16 is a schematic view of a flow path structure in a second embodiment as viewed from the top surface side.

FIG. 17 is a schematic view of a cross section along the main flow direction of a second flow path and a third flow path in the second embodiment.

FIG. 18 is a perspective view of the flow path structure in a second embodiment.

FIG. 19 is a perspective view of a flow path structure in a first modification of the second embodiment.

FIG. 20 is a schematic view of a flow path structure having N first flow path groups, M second flow path groups, and O third flow path groups.

FIG. 21 is an example of a schematic view when using a combination of the flow path structures.

FIG. 22 is a schematic view of a process of preparing the flow path structure.

FIG. 23 is a schematic view of a lipid particle produced using the flow path structure.

FIG. 24 is a flowchart showing an example of a method for producing a lipid particle.

FIG. 25 is an example of a schematic view of the flow path structure used for producing a lipid particle.

### DETAILED DESCRIPTION

A flow path structure according to an embodiment includes: a first flow path group, a second flow path group, a third flow path group, a branch portion, and a merging portion. The first flow path group includes one or more flow paths. The second flow path group is connected to the first flow path group via the branch portion, and includes two or more flow paths. The third flow path group is connected to the second flow path group via the merging portion, and includes one or more flow paths. The branch portion includes a first flow path group side branch opening connected to an end of the flow path included in the first flow path group, the end being close to the second flow path group, and a second flow path group side branch opening connected to an end of the flow path included in the second flow path group, the end being close to the first flow path group. The merging portion includes a second flow path group side merging opening connected to an end of the second flow path group, the end being close to the third flow path group, and a third flow path group side merging opening connected to an end of the third flow path group, the end being close to the second flow path group. Further, when the first flow path group includes N flow paths, the second flow path group includes M flow paths, and M is N or more, a sum of opening areas of the second flow path group side branch openings is equal to or less than M/N times a sum of opening areas of the first flow path group side branch openings, and an opening area of at least one of the second flow path group side merging openings is equal to or smaller than an opening area of at least one of the third flow path group side merging openings.

Embodiments will be described below with reference to the accompanying drawings. In each embodiment, substantially the same constituent parts will be given the same reference numerals, and some descriptions thereof will be omitted. The drawings are schematic, and the relationship between the thickness of each part and the planar dimension, the ratio of the thickness of each part, and the like may differ from the actual one.

When a fluid flows through the flow path structure, the direction of the main flow in the flow path is as shown by the arrow in FIG. 1, and will be described assuming that the direction is substantially along the tube axis direction. That is, the description will be made assuming that the fluid passes from a first flow path, through a second flow path or a third flow path, and then flows through a fourth flow path.

Furthermore, in the present specification, the term “fluid” is not limited to liquid, but may also be gas.

Furthermore, in the present specification, the term “flow path” refers to a space formed inside the flow path structure through which the fluid can flow. The flow path has openings on the upstream side and the downstream side of the fluid. The flow path has a wall surface made of a base material such as resin, glass, ceramics, or metal, and the top surface or the bottom surface of the flow path is sealed by the base material of the flow path structure.

### First Embodiment

FIG. 1 is a schematic view showing an example of a flow path structure 100 according to a first embodiment. In the present embodiment, the flow path structure 100 includes a first flow path 1, a second flow path 2, a third flow path 3, a fourth flow path 4, a branch portion 5, and a merging portion 6. The second flow path 2 is connected to the first flow path 1 via the branch portion 5, the third flow path 3 is connected to the first flow path 1 via the branch portion 5, and the fourth flow path 4 is connected to the second flow path 2 and the third flow path 3 via the merging portion 6. That is, the downstream end of the first flow path 1, the upstream end of the second flow path 2, and the upstream end of the third flow path 3 are connected to the branch portion 5, and the downstream end of the second flow path 2, the downstream end of the third flow path 3, and the upstream end of the fourth flow path 4 are connected to the merging portion 6. Here, “the end of the flow path and the branch portion 5 or the merging portion 6 are connected” refers to a state where the opening of the end of the flow path and the opening of the branch part 5 or the joint part 6 are connected in a liquid-tight manner to communicate with each other's internal spaces to form a continuous space. A material of the flow path structure 100 is not particularly limited, but for example, a resin such as a cycloolefin polymer (COP) may be used.

In the present specification, unless otherwise specified, in FIG. 1, a flow path wall surface positioned closest to the paper surface will be described as a top surface, a flow path wall surface facing the top surface and positioned on a deeper side of the paper surface than the top surface will be described as a bottom surface, and a flow path wall surface intersecting the top surface and the bottom surface will be described as a flow path side surface. In addition, the dimension of the flow path perpendicular to the paper surface, that is, the distance between the top surface and the bottom surface will be described as the flow path depth. The flow path depth is based on a plane including the top surface unless otherwise specified. In FIG. 1, the depth of the flow path is indicated by an oblique line pattern. The darker locations of the hatching pattern indicate relatively shallower depth compared to the white locations. However, the color density of the oblique line pattern is merely a guide, and the depth and the density do not necessarily correspond to each other. On the other hand, in the present specification, unless otherwise specified, a dimension in a direction perpendicular to the tube axis direction and parallel to the paper surface in FIG. 1 will be described as a flow path width.

The flow path widths and the flow path depths of the first flow path 1, the second flow path 2, the third flow path 3, and the fourth flow path 4 are appropriately determined in consideration of various conditions such as the type and flow velocity of the fluid supplied to the flow path structure 100. For example, there is a Reynolds number Re as a numerical value in consideration of the shape of the flow path structure 100, the type of fluid, the flow velocity, and the like. The Reynolds number Re is a dimensionless numerical value defined by the following Formula (1) using ρ [kg/m³]: density of the fluid, V [m/s]: velocity of the fluid, L [m]: representative length, and μ [Pas]: viscosity of the fluid.

$$Re = ρ VL / μ \qquad ( 1 )$$

In the calculation of the Reynolds number of the flow path according to the present embodiment, the hydraulic diameter d_{H} is set as the representative length L. The hydraulic diameter d_{H} is defined by the following Formula (2), where A is a flow path cross-sectional area and P is a flow path cross-sectional edge length.

$${d}_{H} = 4 A / P \qquad ( 2 )$$

The representative length L in obtaining the Reynolds number of the fluid flowing in the flow path is often the hydraulic diameter d_{H}, but the flow path depth, the flow path width, the average value thereof, or the like may be used as the representative length.

In order to generate and sustain a swirling flow, the Reynolds number calculated from the above Formula (1) is preferably 10 or more in the flow path structure 100. In addition, the Reynolds number is preferably less than 2300 in the flow path structure 100 in order to generate a uniform swirling flow and avoid generation of a turbulent flow in the flow path. In particular, when the flow path width and the flow path depth of the first flow path 1 are defined as a “reference width” and a “reference depth”, respectively, the Reynolds number in a section having at least one of the reference width and the reference depth in the flow path is preferably 10 or more. In addition, the Reynolds number is preferably less than 2300 at the third branch opening 53 and the second merging opening 62 where the area of the flow path cross section perpendicular to the tube axis direction in the flow path is the smallest in the drawing. In order to further promote the generation of a uniform swirling flow and further prevent the generation of a turbulent flow in the flow path, it is more preferable that the Reynolds number be approximately 50 or more and 1000 or less in the entire flow path structure 100.

Hereinafter, each part of the flow path structure 100 in the present embodiment will be described in detail.

The first flow path 1 shown in FIG. 1 has a constant flow path width and a constant flow path depth. For example, a case where both the reference flow path width and the reference flow path depth are 0.3 mm will be described as an example. At this time, the average flow velocity of the fluid in the first flow path 1 is preferably approximately 0.1 m/s or more. Assuming that the fluid is close to water and the representative length is the hydraulic diameter, the Reynolds number at this time is around 30 around room temperature. When a pump is used as a device for allowing a fluid to flow into the flow path structure 100 according to the present embodiment, it is preferable to use a pump that does not cause pulsation. As such a pump, a pump having a liquid delivery amount of approximately 1 mL/sec can be easily obtained. In consideration of this circumstance, the reference flow path width and the reference flow path depth are preferably approximately 3 mm or less.

The branch portion 5 shown in FIG. 1 is a part that connects the first flow path 1, the second flow path 2, and the third flow path 3 to each other. The branch portion 5 is connected to the downstream end of the first flow path 1, the upstream end of the second flow path 2, and the upstream end of the third flow path 3. The branch portion 5 includes a first branch opening 51 connected to an end (downstream end) of the first flow path 1 close to the second flow path 2 and the third flow path 3, a second branch opening 52 connected to an end (upstream end) of the second flow path 2 close to the first flow path 1, and a third branch opening 53 connected to an end (upstream end) of the third flow path 3 close to the first flow path 1. The first branch opening 51 is an end of the first flow path, an end of the branch portion, and a boundary between the first flow path and the branch portion 5.

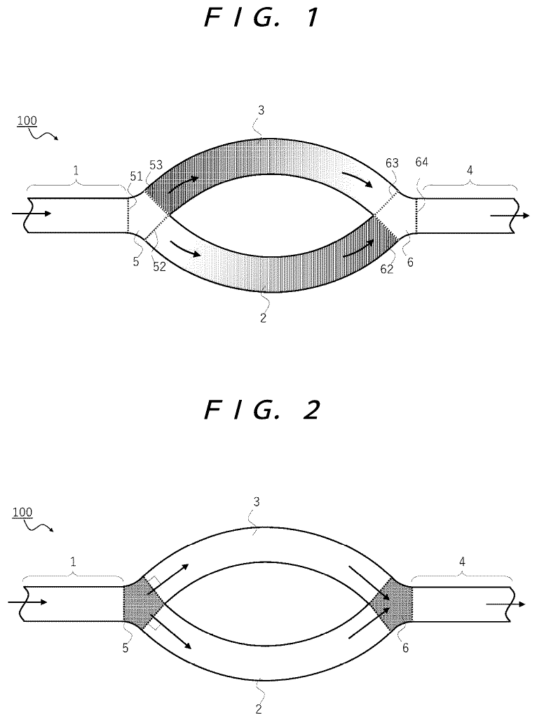

The second branch opening 52 refers to an end of the second flow path, an end of the branch portion, and a boundary between the second flow path and the branch portion. The third branch opening 53 is an end of the third flow path, an end of the branch portion, and a boundary between the third flow path and the branch portion. In the present embodiment, an example is shown in which the flow path width changes across the first branch opening 51, and the second branch opening 52 and the third branch opening 53 are adjacent to each other. As shown in the present example, the cross sections of the second flow path 2 having the second branch opening 52 as an end and the third flow path 3 having the third branch opening 3 as an end do not overlap each other. In the present example, on the inside of the branch portion 5, the cross-sectional area of the flow path decreases from the branch portion 5 side to the first flow path 1. A location where the reduction stops is referred to as the first branch opening 51. Similarly, on the inside of the branch portion 5, a location where the reduction of the cross-sectional area from the branch portion 5 side to the second flow path 2 stops is referred to as the second branch opening 52, and a location where the reduction of the cross-sectional area from the branch portion 5 side to the third flow path 3 stops is referred to as the third branch opening 53. Further, the plane including the first branch opening 51 defines the first branch opening 51 as being perpendicular to the tube axis direction in the first flow path 1. Similarly, the plane including the second branch opening 52 is perpendicular to the tube axis direction in the second flow path 2, and the plane including the third branch opening 53 is perpendicular to the tube axis direction in the third flow path 3. That is, the branch portion 5 corresponds to a shaded region 5 in FIG. 2. Since these openings are set for the sake of convenience to define the region of the branch portion 5, the actual seam of the base material of the flow path structure 100 and the opening defined in the present specification may not coincide with each other. Here, when the area of the region defined as the opening is an opening area, the opening area of at least one of the second branch opening 52 and the third branch opening 53 is equal to or smaller than the opening area of the first branch opening 51. In the present embodiment, a state where at least the third branch opening 53 is equal to or smaller than the opening area of the first branch opening 51 will be described as an example.

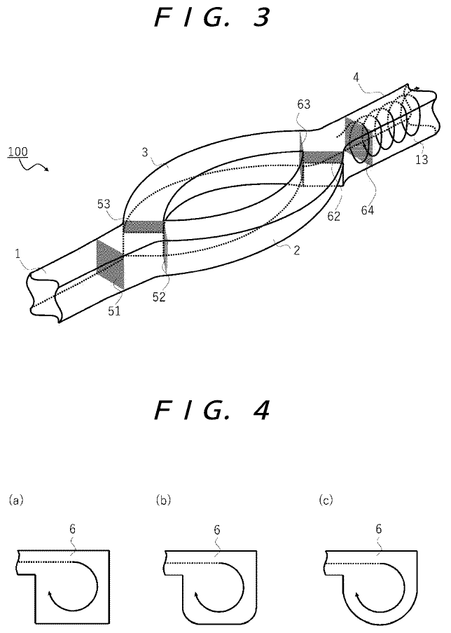

FIG. 3 shows a perspective view of the flow path structure 100. In FIG. 3, an opening area S53 of the third branch opening 53 is equal to or smaller than an opening area S51 of the first branch opening 51. S53 is smaller than S51 and an opening area S52 of the second branch opening 52. In addition, the relationship of S51≈S52+S53 is preferably satisfied. Specifically, the sum of the opening areas of the second branch opening 52 and the third branch opening 53 is preferably less than twice the opening area of the first branch opening 51. The sum of the opening areas of the second branch opening 52 and the third branch opening 53 is more preferably 1.0 times or more and 2.0 times or less, still more preferably 1.0 times or more and 1.9 times or less, and still more preferably 1.0 times or more and 1.5 times or less the opening area of the first branch opening 51. As described above, in the branch portion 5, the opening area of at least one of the second branch opening 52 or the third branch opening 53 is reduced, the opening area of the branch opening on the upstream side (the first branch opening 51) is brought closer to the sum of the opening areas of the branch openings on the downstream side (the second branch opening 52 and the third branch opening 53), and accordingly, it is possible to suppress generation of vortices accompanied by a reverse flow inside one or more regions of the branch portion 5, the second flow path, and the third flow path. Generally, in a flow path in which a flow path cross-sectional area increases, a flow velocity decreases according to the law of flow rate preservation, and a pressure increases accordingly according to Bernoulli's principle. Therefore, at a location where the increase in the flow path cross section is large, a reverse pressure gradient higher in the downstream pressure than in the upstream pressure is generated, and a vortex with a reverse flow may be generated. The vortex accompanied by a reverse flow is, for example, a vortex generated by separation of a flow in the vicinity of a wall surface having a low flow velocity from the wall surface when a reverse pressure gradient increases. On the other hand, when the increase in the flow path cross-sectional area is small, a reverse pressure gradient and vortices accompanied by a reverse flow can be suppressed. Therefore, by bringing the opening area of the branch opening on the upstream side closer to the sum of the opening areas of the branch openings on the downstream side, it is possible to suppress generation of vortices accompanied by a reverse flow in the branch portion.

As shown in FIGS. 1 to 3, the merging portion 6 includes the second merging opening 62 connected to an end (downstream end) of the second flow path 2 close to the fourth flow path 4, a third merging opening 63 connected to an end (downstream end) of the third flow path 3 close to the fourth flow path 4, and a fourth merging opening 64 connected to ends (upstream ends) of the fourth flow path 4 close to the second flow path 2 and the third flow path 3. The second merging opening 62 is an end of the second flow path, an end of the merging portion, and a boundary between the second flow path and the merging portion. The third merging opening 63 is an end of the third flow path, an end of the merging portion, and a boundary between the third flow path and the merging portion. The fourth merging opening 64 is an end of the fourth flow path, an end of the merging portion, and a boundary between the fourth flow path and the merging portion. In the present embodiment, an example is shown in which the second merging opening 62 and the third merging opening 63 are adjacent to each other, and the flow path width changes across the fourth merging opening 64. As shown in the present example, the cross sections of the second flow path 2 having the second merging opening 62 as an end and the third flow path 3 having the third branch opening 3 as an end do not overlap each other. In the present example, on the inside of the merging portion 6, the cross-sectional area of the flow path decreases from the merging portion 6 side to the fourth flow path 4. A location where the reduction stops is referred to as the fourth merging opening 64. Similarly, on the inside of the merging portion 6, a location where the reduction of the cross-sectional area from the branch portion 6 side to the second flow path 2 stops is referred to as the second merging opening 62, and a location where the reduction of the cross-sectional area from the branch portion 6 side to the third flow path 3 stops is referred to as the third merging opening 63. Further, the plane including the second merging opening 62 defines the second branch opening 62 as being perpendicular to the tube axis direction in the second flow path 2. Similarly, the plane including the third merging opening 63 is perpendicular to the tube axis direction in the third flow path 3, and the plane including the fourth merging opening 64 is perpendicular to the tube axis direction in the fourth flow path 4. That is, the merging portion 6 corresponds to the shaded region 6 in FIG. 2. Since these openings are set for the sake of convenience to define the region of the merging portion 6, the actual seam of the base material of the flow path structure 100 and the opening defined in the present specification may not coincide with each other.

An opening area of at least one of the second merging opening 62 and the third merging opening 63 is equal to or smaller than an opening area of the fourth merging opening 64. In the present embodiment, an opening area S62 of the second merging opening 62 is equal to or smaller than an opening area S64 of the fourth merging opening 64. S62 is smaller than S64 and an opening area S63 of the third merging opening 63. Further, in the vicinity of the second merging opening 62, the flow path depth of the second flow path 2 is shallower than the flow path depths of the third flow path 3 and the fourth flow path 4. Further, the normal direction of the second merging opening 62 is different from the tube axis direction of the third flow path 3 and fourth flow path 4. With this structure, the fluid flowing from the second flow path 2 into the merging portion 6 collides with at least a part of the wall surface of the merging portion 6 and the wall surfaces of the third flow path 3 and the fourth flow path 4, and accordingly, a vortex having a velocity component substantially perpendicular to the wall surface colliding with the fluid flowing from the second flow path 2 into the merging portion 6 and a velocity component in the flow path depth direction is generated, and further, the fluid is merged with the fluid supplied from the third flow path 3 to form a swirling flow (swirl) 13 in which the tube axis direction and the rotation axis of the fourth flow path are parallel to each other. As described above, in the merging portion 6, the end of at least one flow path on the upstream side is made shallow, and a difference is made between the normal direction of the end surface of the flow path made shallow and the tube axis direction of the flow path on the downstream side, and accordingly, a swirling flow can be generated.

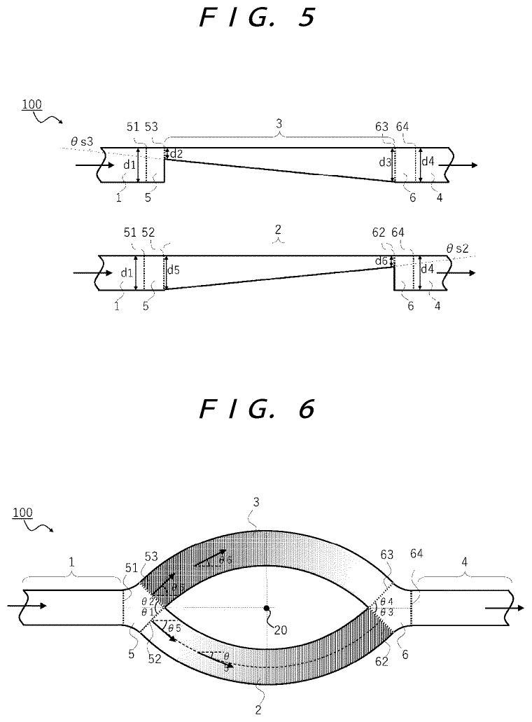

FIG. 4 shows a cross-sectional view of the merging portion 6 perpendicular to the second merging opening 62. The shape of the cross section of the merging portion 6 is preferably a square having the same width and depth as shown in FIG. 4A. However, it is not necessary to form a square shape precisely, and a substantially square shape having one side slightly long may be used. In addition, if possible, as shown in FIG. 4B, a shape in which two corners of the bottom portion of the cross section are formed in a curved surface shape or an R shape is also preferable, or as shown in FIG. 4C, the bottom portion of the cross section may be formed in a curved surface shape or an R shape in which a distance of half a side of a square is a radius. With such a cross-sectional shape, the transverse vortex has a shape closer to a perfect circle, and the transverse vortex is maintained longer. As a result, the fluid can be well mixed and stirred. Such a cross-sectional shape is not limited to only the merging portion 6, but may be such a cross-sectional shape throughout the entire flow path. In the present embodiment, since the flow path width is constant, the opening area depends on the flow path depth. Here, FIG. 5 is a schematic view of cross sections of the second flow path 2 and the third flow path 3 along the tube axis direction. As shown in FIG. 5, a flow path depth d6 in the second merging opening 62 is preferably less than ½ of a flow path depth d4 in the fourth merging opening 64. In addition, d6/d4 is more preferably ⅓ or less. By setting the value of d6/d4 in this manner, the velocity when the fluid flows from the second flow path 2 into the merging portion 6 according to the law of flow rate preservation increases, and a stronger swirling flow is likely to be generated. The flow path depth d6 is shallower to obtain a flow velocity capable of generating a stronger swirling flow, but if the flow path depth d6 is extremely shallow, an excessive pressure loss may occur. In addition, when there are foreign matters, there is a possibility of causing blockage. Therefore, by experiment or simulation, while d6/d4 is changed to a smaller value of, for example, 1/1, 1/2, 1/3, . . . as the flow path depth d6 is designed shallower, a condition having the shallowest flow path depth d6 may be set among setting conditions under which desired indices, such as the mixing degree, the dilution degree, the product quality (particle size distribution and encapsulated substance concentration), the precision in flow path machining, the pressure loss, or the robustness against foreign matters, are determined to be appropriate based on the experiment result. An example in which the cross-sectional areas of the second flow path 2 and the third flow path 3 are continuously changed by changing the flow path depth has been described above. However, instead of changing the flow path depth, the cross-sectional areas of the second flow path 2 and the third flow path 3 may be continuously changed by continuously changing at least a part of the flow path width.

The third flow path 3 in the present embodiment is substantially symmetric with respect to the second flow path 2. For example, in the second flow path 2, the opening area S62 of the second merging opening 62 is smaller than the opening area S52 of the second branch opening 52, and the cross-sectional area of the second flow path 2 decreases from upstream to downstream, whereas in the third flow path 3, the opening area S63 of the third merging opening 63 is larger than the opening area S53 of the third branch opening 53, and the cross-sectional area of the third flow path 3 increases from upstream to downstream. In addition, a value obtained by dividing S62 by S52 is preferably 0.5 times or more and 2.0 times or less, and more preferably 0.8 times or more and 1.2 times or less a value obtained by dividing S53 by S63. Further, it is most preferable that a value obtained by dividing S62 by S52 be equal to a value obtained by dividing S53 by S63.

In the flow path structure 100 according to the present embodiment, S52 is 0.5 times or more and 2.0 times or less of S63, or/and S53 is preferably 0.5 times or more and 2.0 times or less of S62, S52 is 0.8 times or more and 1.2 times or less of S63, or/and S53 is more preferably 0.8 times or more and 1.2 times or less of S62. In addition, it is most preferable that S52 and S63 be equal, and/or S53 and S62 be equal. In the present embodiment, S53 is equal to S62, and S63 is equal to S52.

In this manner, by making the structures of each end of the second flow path 2 and the third flow path 3 symmetric, it is possible to bring the flow rates of the fluids flowing through the second flow path and the third flow path 3 close to each other. The larger the flow rate difference between the second flow path 2 and the third flow path 3, the more difficult it is to mix quickly, and there is a possibility that it is difficult to adjust the pressure in the flow path with the smaller flow rate. Therefore, from the viewpoint of the robustness of the product, it is preferable to distribute the flow approximately equally.

Note that, since the precision of die molding or cutting, which is a preferable method for producing the flow path structure 100, is generally 5 μm, in consideration of the precision in flow path machining, the flow path depth d6 is desirably 10 μm or more.

In order to generate a uniform swirling flow and avoid the occurrence of a turbulent flow and cavitation in the flow path, it is preferable to avoid excessively reducing the flow path depth d6 and excessively reducing the opening area of the second merging opening 62. In order to avoid the generation of a turbulent flow, it is preferable to set the opening area such that the Reynolds number is less than 2300. Further, from the viewpoint of suppressing cavitation and avoiding clogging due to bubbles or the like in the flow path, the flow path width and the flow path depth of the first to third branch openings (51, 52, 53) and the second to fourth merging openings (62, 63, 64) are preferably 5 μm or more.

At least a part of the second flow path 2 and the third flow path 3 has a structure in which the shape of a cross section perpendicular to the tube axis direction of the flow path continuously changes. For example, in the present embodiment, the shape of the cross section perpendicular to the tube axis direction of the second flow path 2 continuously changes from the second branch opening 52 toward the second merging opening 62, and the shape of the cross section perpendicular to the tube axis direction of the third flow path 3 continuously changes from the third branch opening 53 toward the third merging opening 63. Here, “continuously change” means that the shape of the flow path changes smoothly and the shape of the cross section does not suddenly change. In the second flow path 2 and the third flow path 3, it is preferable that the area of the flow path cross section continuously change from the upstream side to the downstream side, the shape of the flow path smoothly change, and the cross-sectional area do not suddenly change. According to the present embodiment, since the flow path width is constant, at least a part of the second flow path 2 has a structure in which the flow path depth continuously changes. Here, “continuously change” means that the shape of the flow path smoothly changes and the flow path depth does not suddenly change. In general, vortices accompanied by a reverse flow formed by a fluid that cannot follow the main flow may be generated on the downstream side at a location where the area of the flow path cross section suddenly increases, and on the upstream side at a location where the area of the flow path cross section suddenly decreases. Therefore, by designing the second flow path 2 and the third flow path 3 such that the area of the flow path cross section does not suddenly change from the upstream side to the downstream side, it is possible to suppress the generation of vortices accompanied by a reverse flow in the second flow path and the third flow path 3. In the second flow path 2 and the third flow path 3 shown in FIG. 5, the flow path depth continuously changes, and the bottom surface has a slope shape. An angle formed by the bottom surface and the top surface in the second flow path 2 is defined as a divergence angle θs2, and an angle formed by the bottom surface and the top surface in the third flow path 3 is defined as a divergence angle θs3. θs2 and θs3 are not limited, but are preferably 10° or less, for example. More generally, in a section of any distance W in the flow path, when the hydraulic diameter at the upstream end in the section is denoted by d_{H1}, the hydraulic diameter at the downstream end is denoted by d_{H2}, and the divergence angle is denoted by θs, it is desirable that W, d_{H1}, and d_{H2} satisfy the following Relational Formula (3) while θs is set to 10° or less.

$${d}_{H 2} = {d}_{H 1} + 2 \times W \times tan ( θ s / 2 ) \qquad ( 3 )$$

As described above, by limiting the upper limit value of the divergence angle in the flow path accompanied by enlargement or reduction of the cross-sectional area, it is possible to suppress the generation of vortices accompanied by a reverse flow due to the reverse pressure gradient.

FIG. 6 is a schematic view showing an example of the flow path structure 100 according to the first embodiment. An angle θ5 formed by the tube axis direction of the flow in the second flow path 2 and the tube axis direction of the first flow path 1 changes from the upstream side to the downstream side in the second flow path 2. Similarly, an angle θ6 formed by the tube axis direction of the third flow path 3 and the tube axis direction of the first flow path 1 changes from the upstream side to the downstream side in the third flow path 3. In general, when the direction of the main flow suddenly changes, vortices accompanied by a reverse flow may be generated by a fluid that cannot follow the main flow. Therefore, by designing the second flow path 2 and the third flow path 3 such that the tube axis direction (that is, the normal direction of the cross section) changes continuously from the upstream side to the downstream side, it is possible to suppress the generation of vortices accompanied by a reverse flow in the second flow path and the third flow path 3.

In FIG. 6, an angle formed by the tube axis direction in the first flow path 1 and the surface including the second branch opening 52 is defined as θ1, an angle formed by the tube axis direction in the first flow path 1 and the surface including the third branch opening 53 is defined as θ2, an angle formed by the surface including the second branch opening 52 and the tube axis direction in the fourth flow path 4 is defined as θ3, and an angle formed by the surface including the third branch opening 53 and the tube axis direction in the fourth flow path 4 is defined as θ4. In the flow path structure 100, it is preferable that θ1 and θ4 and θ2 and θ3 have the same size. That is, it is preferable that the upstream end of the second flow path 2 and the downstream end of the third flow path 3, and the upstream end of the third flow path 3 and the downstream end of the second flow path 2 be symmetric with respect to a center point 20, which is the midpoint between the branch portion 5 and the merging portion 6. The magnitudes of θ1 to θ4 are not particularly limited, but it is preferable that each be greater than 0° and less than 90°, for example. Further, it is more preferable that each of θ1 to θ4 have a magnitude of 0° or more and 70° or less.

It is preferable that the second flow path 2 and the third flow path 3, including the intermediate flow paths other than each end of the second flow path 2 and the third flow path 3, have an approximately point symmetric shape with a midpoint between the branch portion 5 and the merging portion 6 as a center point 20. The center point 20 is the midpoint of the line segment that connects the intersection point on the branch portion 5 side and the intersection point on the branching portion 6 side of the extension lines of the tube axes of each of the second flow path 2 and the third flow path 3 when viewed from a cross section parallel to the paper surface of FIG. 1. By making the shapes of each of the flow paths from the branch portion 5 to the merging portion 6 similar, it is possible to make the flow rates of the fluids flowing through the second flow path 2 and the third flow path 3 even closer to the same amount.

Above, an example was described in which the tube axis direction of the second flow path 2 and the third flow path 3, the angle between the bottom surface and the top surface, and the cross-sectional area of the flow path change uniformly over the entire area of the second flow path 2. In this manner, by making changes in the entire area of the second flow path 2 and the third flow path 3 and increasing the region where the tube axis direction and the cross-sectional area change, it is possible to suppress the rate of change in the tube axis direction of the flow path, the angle between the bottom surface and the top surface, and the cross-sectional area of the flow path. Therefore, from the viewpoint of suppressing vortices accompanied by a reverse flow in the second flow path 2 and the third flow path 3, it is preferable to make changes in the entire area of the second flow path 2 and the third flow path 3. However, the tube axis direction of the flow path, the angle between the bottom surface and the top surface, and the cross-sectional area of the flow path do not necessarily need to make changes in the entire area of the second flow path 2 and the third flow path 3.

The flow path width of the fourth flow path 4 in the present embodiment is constant. The end on the upstream side of the fourth flow path 4 and the merging portion 6 are connected to each other via the fourth merging opening 64. The opening on the downstream side of the fourth flow path 4 may be connected to a flow path structure other than the flow path structure 100.

In the fourth flow path 4, the swirling flow 13 is formed (FIG. 3). The rotation axis of the swirling flow 13 is approximately parallel to the main axis of the fourth flow path 4. From the upstream side to the downstream side of the fourth flow path 4, the swirling flow 13 persists over a longer distance than a transverse vortex, and thus the mixing of the fluid that has flowed into the fourth flow path 4 via the third flow path 3 and the fluid that has flowed into the fourth flow path 4 via the second flow path 2 is promoted, and the fluids are stirred. Furthermore, unlike a transverse vortex, the swirling flow 13 does not include a flow in the direction opposite to the tube axis direction in the fourth flow path 4. Accordingly, the difference in the degree of mixing between substances caught in the reverse flow and substances that are not caught in the reverse flow is eliminated, and thus it is possible to achieve more uniform mixing.

By using such a flow path structure 100 for mixing fluids, it is possible to effectively mix fluids due to the swirling flow generated within the flow path. For example, when a solvent is mixed with a solution and stirred, the solution becomes diluted compared to the state before mixing. At this time, more uniform dilution can be achieved by effectively mixing and even stirring the fluids.

In the present embodiment, the case where both the reference flow path width and the reference flow path depth are 0.3 mm has been described as an example, but the dimensions of the flow path do not have to be of this order. The opening area of the flow path included in the flow path structure 100 is preferably 100 mm² or less, but from the viewpoint of reducing pressure loss, suppressing cavitation, and avoiding clogging due to bubbles in the flow path, the flow path width and the flow path depth are preferably 5 μm or more.

In addition, in the present embodiment, from the viewpoint of ensuring the strength of the mold for mass-producing the flow path, when the flow path depth is defined as L and the flow path width is defined as W, it is preferable that the ratio L/W be 1 or less.

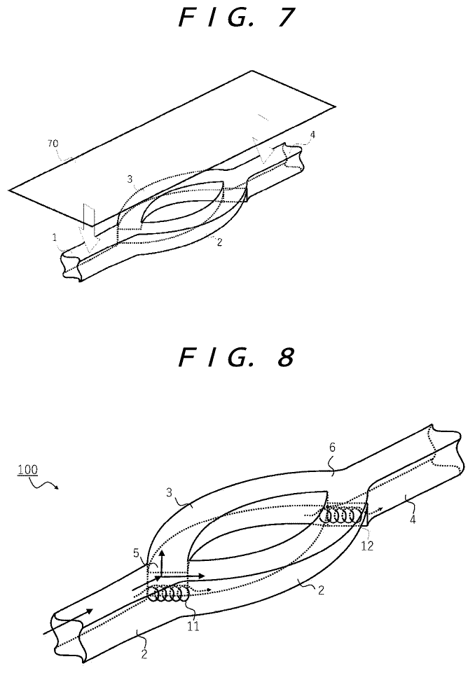

Note that the flow path side surface of the flow path structure 100 shown in FIG. 1 consists of a surface parallel to the normal to the paper surface of FIG. 1. Although it is not necessary for the flow path side surfaces to be parallel to the normal to the paper surface of FIG. 1 in this manner, by designing the flow path side surfaces to be parallel to the normal to the paper surface of FIG. 1, it becomes possible to easily make a flow path simply by machining in one direction perpendicular to the paper surface. In addition, the top surface of the flow path structure 100 is included in a single plane, extending from the top surface of the first flow path 1 to the top surface of the second flow path 2, the top surface of the third flow path 3, and the top surface of the fourth flow path 4. By designing the top surface to be included in a single plane, as shown in FIG. 7, it becomes possible to use a single flat plate-like member 70 as the member for the top surface of the flow path structure 100. Accordingly, it becomes possible to prepare the flow path structure 100 by simply covering and sealing the flow path with a single flat plate, which has been processed on the side surface and the bottom surface, and thus, the preparing cost becomes more economical, and it becomes possible to prepare the flow path structure 100 with higher precision. However, the top surface does not necessarily need to be included in a single plane.

FIG. 8 is a perspective view of the flow path structure 100. FIG. 8 is a view showing some vortices other than the swirling flow 13 that may be generated at the merging portion 6 and the branch portion 5. The cross section suddenly decreases on the upstream side and the downstream side of the third branch opening 53. Therefore, at the corner provided immediately below (in the depth direction) the third branch opening 53, a vortex 11 may be generated by the fluid that cannot follow the main flow due to a sudden reduction in cross section. When the second flow path 2 does not exist, the vortex 11 becomes a vortex with a reverse flow, but since the rotation axis of the vortex 11 is substantially parallel to the normal direction of the second branch opening 52, the vortex 11 is swept away toward the second flow passage 2 and becomes a swirling flow. On the other hand, the cross-sectional area suddenly expands on the upstream side and the downstream side of the second merging opening 62. Therefore, at the corner provided immediately below (in the depth direction) the second merging opening 62, a vortex 12 may be generated by the fluid that cannot follow the main flow due to a sudden increase in the cross-sectional area. When the third flow path 3 does not exist, the vortex 12 becomes a vortex accompanied by a reverse flow, but since the rotation axis of the vortex 12 is substantially parallel to the normal direction of the third merging opening 63, the vortex 12 is swept away by the flow flowing out from the third flow path 3 and becomes a swirling flow. By converting these vortices with reverse flow into swirling flows, more uniform mixing can be achieved.

### (First Modification)

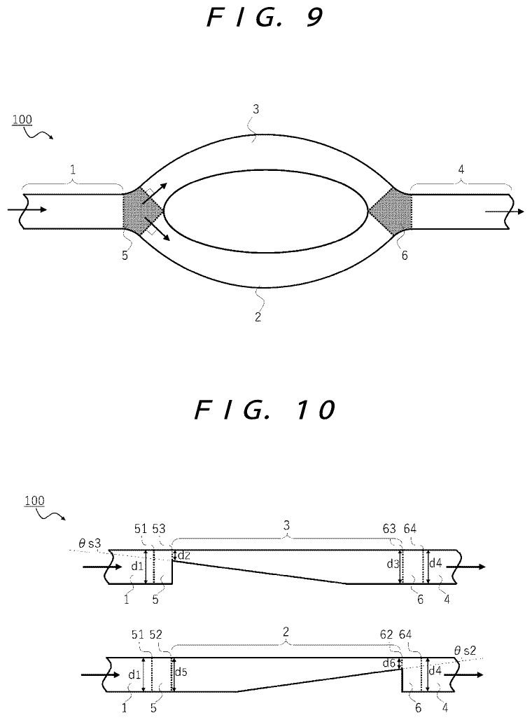

FIG. 9 is an example of a schematic view of the flow path structure 100 in the present modification. As described above, the second flow path 2 and the third flow path 3 may be smoothly connected to each other at a location where the second branch opening 52 and the third branch opening 53 are adjacent to each other. Similarly, the second flow path 2 and the third flow path 3 may be smoothly connected to each other at a location where the second merging opening 62 and the third merging opening 63 are adjacent to each other.

### (Second Modification)

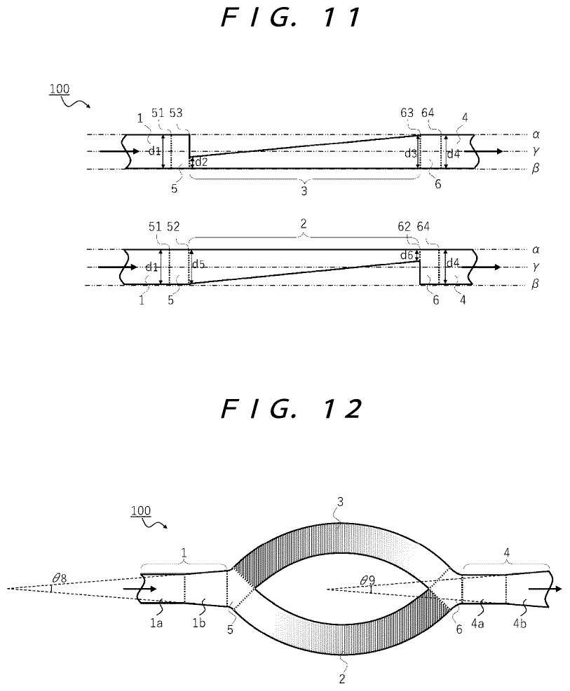

In the first embodiment, an example has been described in which the flow path structure 100 uniformly changes the tube axis direction of the flow path, the angle formed by the bottom surface and the top surface, and the cross-sectional area of the flow path in the entire region of the second flow path 2 or the third flow path 3 in the entire range from the branch portion 5 to the merging portion 6, but the region where the tube axis direction of the flow path, the angle formed by the bottom surface and the top surface, and the cross-sectional area of the flow path change may not be the entire region. In addition, in the second flow path 2 and the third flow path 3, the rate of change in the tube axis direction of the flow path, the angle formed by the bottom surface and the top surface, or the cross-sectional area of the flow path may not be constant. In the present modification, the flow path structure 100 having a region where the angle formed by the bottom surface and the top surface does not change in the second flow path 2 and the third flow path 3 will be described. FIG. 10 is a schematic view of a cross section along the tube axis direction of the flow path structure 100 in the present modification. In FIG. 10, a flow path depth in a region of the second flow path 2 close to the branch portion 5 is constant, and a flow path depth in a region of the third flow path 3 close to the merging portion 6 is constant. With such a structure of the second flow path 2 and the third flow path 3, it is possible to lengthen a region having a large flow path cross-sectional area and to reduce a pressure loss in the second flow path 2 and the third flow path 3. In the present embodiment, it is particularly preferable that the region where the flow path depth changes and the region where the flow path depth does not change be smoothly connected to each other.

### (Third Modification)

FIG. 11 is a schematic view of a cross section along the tube axis direction of the flow path structure 100 in the present modification. In the flow path structure 100 of the present modification, the top surface of the first flow path 1, the top surface of the second flow path 2, and the top surface of the fourth flow path 4 are included in a single plane. This plane is defined as a plane α. On the other hand, the bottom surface of the first flow path 1, the bottom surface of the third flow path 3, and the bottom surface of the fourth flow path 4 are included in a single plane different from the plane α. A plane including the bottom surface of the first flow path 1, the bottom surface of the third flow path 3, and the bottom surface of the fourth flow path 4 is defined as a plane β. By designing such that the top surface of the first flow path 1, the top surface of the second flow path 2, and the top surface of the fourth flow path 4 are included in a single plane α, a member for the top surface can be a single flat plate-like member. Similarly, by designing such that a plane including the bottom surface of the first flow path 1, the bottom surface of the third flow path 3, and the bottom surface of the fourth flow path 4 is included in the single plane β, the member for the bottom surface can be a single flat plate-like member. Accordingly, it becomes possible to prepare the flow path structure 100 simply by sealing a flow path obtained by processing a side surface and a bottom surface or a side surface and a top surface to be sandwiched between two flat plates. Therefore, for example, as compared with a case where the flow paths divided by a plane γ shown in the drawing are respectively made and these flow paths are butted against each other to prepare a flow path structure, a deviation between the flow paths that may occur in joining of fine flow paths does not occur, and the flow path structure 100 can be made with higher precision.

### (Fourth Modification)

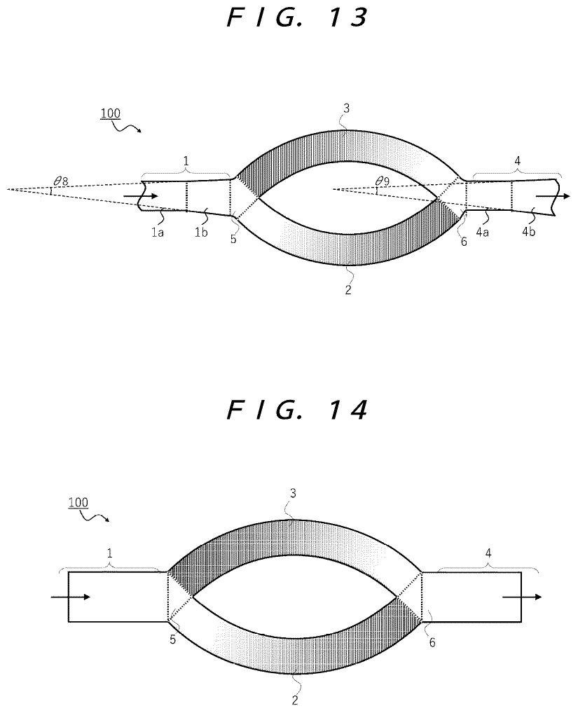

FIG. 12 is a schematic view showing an example of the flow path structure 100 in the present modification. In at least a part of the first flow path 1, a shape of a cross section perpendicular to the tube axis direction in the first flow path 1 continuously changes as approaching the first branch opening 51. Assuming that a region far from the branch portion 5 in the first flow path 1 is defined as a region 1a, and a region between the region 1a and the branch portion 5 is defined as a region 1b, a cross-sectional area of the region 1b increases from the region 1a toward the branch portion 5. In this manner, by enlarging the opening area S51 of the first branch opening 51, the sum of the cross-sectional areas of the flows flowing into the branch portion 5 and the sum of the cross-sectional areas of the flows flowing out from the branch portion 5 can be brought closer to each other, and it becomes possible to suppress vortices accompanied by a reverse flow due to a sudden increase in the cross-sectional area in the branch portion 5. However, when a divergence angle θ8 of the region 1b is extremely large, vortices accompanied by a reverse flow may be generated in the region 1b, and thus θ8 is preferably 10° or less. However, this value does not limit the shape of the flow path structure 1.

Although not shown, when another flow path structure 100 is further provided on the downstream side of the flow path structure and used, the fourth flow path 4 in the drawing is connected to the branch portion 5 of another flow path structure. At this time, assuming that a region of the fourth flow path 4 far from the merging portion 6 in the drawing is defined as a region 4b, and a region between the region 4b and the merging portion 6 in the drawing is defined as a region 4a, the cross-sectional area of the region 4b increases from the region 4a toward the branch portion 5 of another flow path structure. A divergence angle θ9 of the region 4b is preferably 10° or less similarly to θ8, but θ8 and θ9 do not necessarily have to be the same value.

### (Fifth Modification)

FIG. 13 is a schematic view showing an example of the flow path structure 100 in the present modification. In the present modification, similarly to the fourth modification, the cross-sectional area of the region 1b increases from the region 1a toward the branch portion 5. However, unlike the fourth modification, the cross-sectional area of the region 1b increases while being biased toward the flow path connected to the downstream side of the branch portion 5, which has the largest opening area at the boundary with the branch portion 5. In the present modification, among the flow paths connected to the downstream side of the branch portion 5, the opening area of the second branch opening 52 which is the boundary between the second flow path 2 and the branch portion 5 is the largest, and thus the cross-sectional area of the region 1b increases while being biased toward the second flow path 2. In the vicinity of the boundary between the branch portion 5 and the flow path having the largest opening area downstream thereof, the flow is more likely to be separated, and reverse flow is likely to be generated. Therefore, as shown in the present modification, by increasing the cross-sectional area of the flow path on the upstream side with respect to the branch portion 5 while being biased toward the flow path having the largest opening area downstream of the branch portion 5, it is possible to suppress the separated flow accompanied by a reverse flow. Similarly, in the fourth flow path 4, the cross-sectional area of the region 4b also increases while being biased toward one side. Although not shown, it is assumed that the same structure as that of the branch portion 5 is connected to the downstream side of the fourth flow path 4, and a flow path having the same structure as that of the second flow path 2 and the third flow path 3 is arranged and connected to the further downstream side of the fourth flow path 4 in the same positional relationship as that of the second flow path 2 and the third flow path 3 shown in the drawing.

### (Sixth Modification)

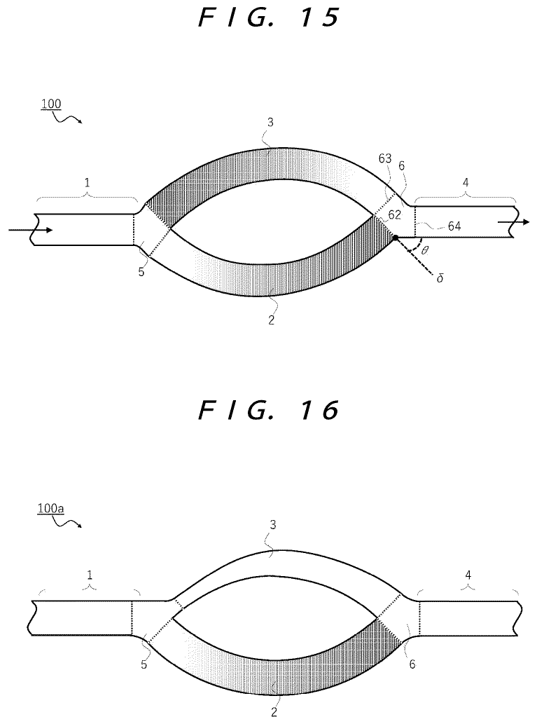

FIG. 14 is a schematic view showing an example of the flow path structure 100 according to the present modification. The cross sections of the first flow path 1 and the fourth flow path 4 are larger than the cross sections of the second flow path 2 and the third flow path 3. By designing the flow path upstream of the branch portion 5 to be larger in this manner, the sum of the cross-sectional area at the end on the upstream side and the sum of the cross-sectional area at the end on the downstream side with respect to the branch portion can be brought closer to each other, and it becomes possible to suppress vortices accompanied by a reverse flow due to a sudden increase in the cross-sectional area.

### (Seventh Modification)

FIG. 15 is a schematic view showing an example of the flow path structure 100 according to the present modification. In the present modification, a plane obtained by extending the downstream end of the side surface close to the second flow path 2 among side surfaces of the third flow path 3 is defined as a plane δ. The second merging opening 62, which is a boundary between the second flow path 2 and the merging portion 6, is included in the plane δ.

The merging portion 6 according to the present embodiment does not necessarily have a substantially line symmetric shape with the tube axis direction of the first flow path 1 as an axis. For example, in FIG. 15, while the side surface between the second merging opening 62 and the fourth merging opening 64 is a plane, the side surface between the third merging opening 63 and the fourth merging opening 64 partially includes a curved surface. The side surface between the second merging opening 62 and the fourth merging opening 64 is formed by extending the fourth flow path 4 toward the first flow path 1, and the angle θ formed by the side surface and the plane δ is smaller than that in the case of FIG. 1, for example.

With such a configuration, it is possible to alleviate the collision of the flow flowing out from the third flow path 3 with the side surface of the merging portion 6 and to suppress the generation of the vortex accompanied by a reverse flow.

### Second Embodiment

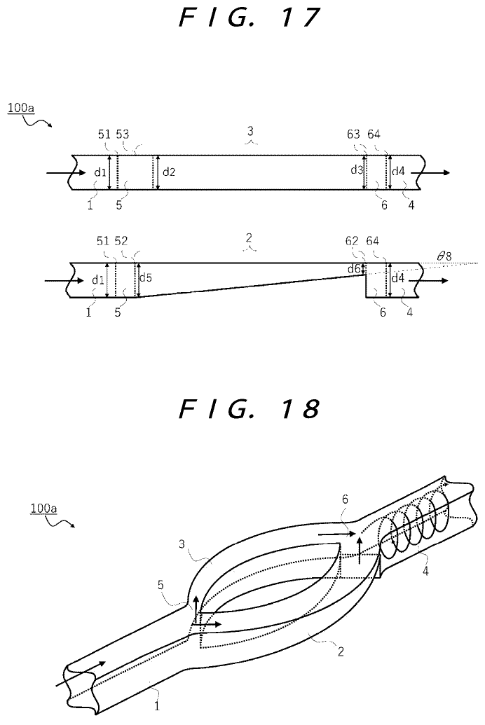

FIGS. 16 to 18 are a schematic view of a flow path structure 100a according to the present embodiment as viewed from the top surface side, a schematic view of a cross section along the tube axis direction of the second flow path 2 and the third flow path 3 of the flow path structure 100a, and a perspective view of the flow path structure 100a, respectively. At the location where the branch portion 5 is connected to the second flow path 2 and the third flow path 3, the flow path depths of the second flow path 2 and the third flow path 3 are the same as the depth of the first flow path 1. However, the flow path width of the second flow path 2 is narrower than the flow path width of the first flow path 1. In the first embodiment, the flow path depth of the second flow path 2 is made shallow to make the sum of the cross-sectional area of the flow flowing into the branch portion 5 closer to the sum of the cross-sectional area of the flow flowing out of the branch portion 5, but in the present embodiment, the flow path width is narrowed to make the sum of the cross-sectional area of the flow flowing into the branch portion 5 closer to the sum of the cross-sectional area of the flow flowing out of the branch portion 5, and thus the generation of vortices accompanied by reverse flow is suppressed.

### (First Modification)

FIG. 19 is an example of a schematic view of the flow path structure 100a in the present modification. At the location where the merging portion 6 is connected to the second flow path 2 and the third flow path 3, the flow path depth of the third flow path 3 is the same as the depth of the fourth flow path 4. However, the flow path width of the third flow path 3 is narrower than the flow path width of the fourth flow path 4. In the second embodiment, the flow path width of the third flow path 3 is the same as the flow path width of the fourth flow path 4, but in the present embodiment, by narrowing the flow path width, the velocity when the fluid flows from the second flow path 2 into the merging portion 6 increases, and a stronger swirling flow is likely to be generated.

### Third Embodiment

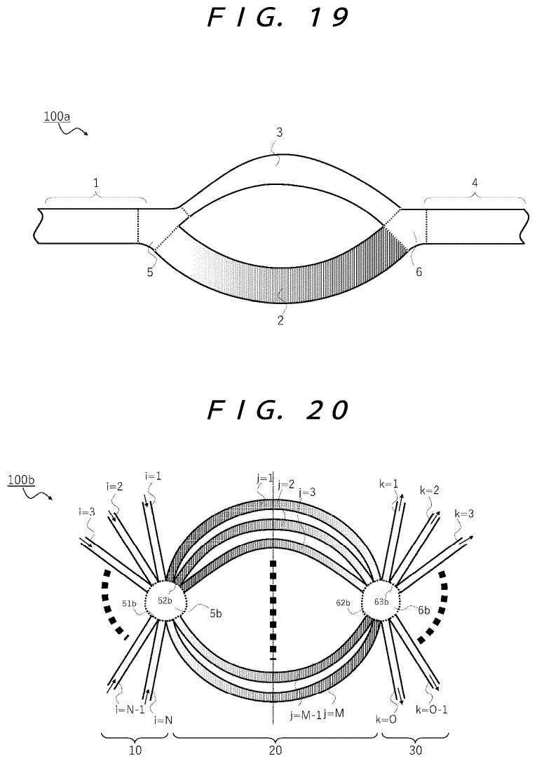

In the first and second embodiments, an example has been described in which one first flow path 1 is provided on the upstream side of the branch portion 5, two flow paths of the second flow path 2 and the third flow path 3 are provided on the downstream side of the branch portion 5, and one fourth flow path 4 is provided on the downstream side of the merging portion 6, but the number of flow paths is not limited thereto. FIG. 20 shows a schematic view of a flow path structure 100b including N flow paths (where 1≤N) on the upstream side of the branch portion 5b and M flow paths (where 2≤M) on the downstream side, and including M flow paths on the upstream side of the merging portion 6b and O flow paths (where 1≤O) on the downstream side. In the present embodiment, the N flow paths on the upstream side of the branch portion 5b are collectively referred to as a first flow path group 10, the M flow paths on the downstream side of the branch portion 5b and on the upstream side of the merging portion 6b are collectively referred to as a second flow path group 20, and the O flow paths on the downstream side of the merging portion 6b are collectively referred to as a third flow path group 30. The flow path structure 100b includes the first flow path group 10 including one or more flow paths, the second flow path group 20 connected to the first flow path group 10 via the branch portion 5b and including two or more flow paths, and the third flow path group 30 connected to the second flow path group via the merging portion 6b and including one or more flow paths. The branch portion 5b includes a first flow path group side branch opening 51b connected to an end of the flow path included in the first flow path group 10, the end being close to the second flow path group 20, and a second flow path group side branch opening 52b connected to an end of the flow path included in the second flow path group 20, the end being close to first flow path group 10. The merging portion 6b includes a second flow path group side merging opening 62b connected to an end of the second flow path group 20, the end being close to the third flow path group 30, and a third flow path group side merging opening 63b connected to an end of the third flow path group 30, the end being close to the second flow path group 20. Here, since the second flow path group side branch opening 51b is a boundary between each flow path included in the first flow path group 10 and the branch portion 5b, there are as many first flow path group side branch openings 51b as the number (N) of the flow paths included in the first flow path group 10. Similarly, since the second flow path group side branch opening 52b is a boundary between each flow path included in the second flow path group 20 and the branch portion 5b, there are as many second flow path group side branch openings 52b as the number (M) of the flow paths included in the second flow path group 20. Further, when M is N or more, with respect to the total ΣSi of the opening areas of the first flow path group side branch openings 51b and the total ΣSj of the opening areas of the second flow path group side branch openings 52b, ΣSj is preferably 1.0 times or more and M/N times or less, and more preferably 0.75×M/N times or less, with respect to ΣSi. Furthermore, it is desirable that the relationship of ΣSj & ΣSi be satisfied. In this manner, the total opening area of the first flow path group side branch opening 51b does not exceed the total opening area of the second flow path group side branch opening 52b, and accordingly, it is possible to suppress vortices accompanied by a reverse flow generated by a sudden cross-sectional area change.

In a case where ΣSj/ΣSi is larger than 1, it is possible to suppress vortices accompanied by a reverse flow as the ΣSj/ΣSi approaches 1, but there is a possibility that an excessive pressure loss occurs in a pipe in which the cross-sectional area is narrowed in an attempt to approach 1. In addition, when there are foreign matters, there is a possibility of causing blockage. Therefore, by experiment or simulation, while ΣSj/ΣSi is changed to a smaller value of, for example, 1.0×(M/N), 0.9×(M/N), 0.8×(M/N) . . . as ΣSi and ΣSj are brought closer to each other, a condition having ΣSj/ΣSi closest to 1 may be set among setting conditions under which desired indices, such as the suppression degree of vortices accompanied by a reverse flow, the mixing degree, the dilution degree, the product quality (particle size distribution and encapsulated substance concentration), the precision in flow path machining, the pressure loss, or the robustness against foreign matters, are determined to be appropriate based on the experiment result.

The opening area of at least one of the second flow path group side branch openings 52b is equal to or smaller than the opening area of at least one of the first flow path group side branch openings 51b.

Since the second flow path group side merging opening 62b is a boundary between each flow path included in the second flow path group 20 and the merging portion 6b, there are as many second flow path group side merging openings 62b as the number (M) of the flow paths included in the second flow path group 20. Similarly, since the third flow path group side merging opening 63b is a boundary between each flow path included in the third flow path group 30 and the merging portion 6b, there are as many third flow path group side merging openings 63b as the number (O) of the flow paths included in the third flow path group 30. In the j-th opening area Sj′ of the second flow path group side merging opening 62b and the k-th opening area Sk of the third flow path group side merging opening 63b, at least one of Sj′ may be smaller than at least one of Sk.

The flow path included in the second flow path group 20 is a flow path that connects the branch portion 5b and the merging portion 6b to each other. In at least one flow path included in the second flow path group 20, the opening area of the second flow path group side merging opening 62b is smaller than the opening area of the second flow path group side branch opening 52b, and the cross-sectional area of the flow path decreases from upstream to downstream.

In addition, at least some of the flow paths included in the second flow path group 20 has a structure in which the shape of the cross section perpendicular to the tube axis direction of the flow path continuously changes. For example, a structure in which the flow path depth continuously changes or a structure in which the flow path width continuously changes may be used.

The top surfaces of the flow paths included in the first flow path group 10, the second flow path group 20, and the third flow path group 30 are preferably included in a single plane. By designing the top surface to be included in a single plane, as shown in FIG. 7, a member for the top surface of the flow path structure 100b can be a single flat plate-like member. Accordingly, it becomes possible to prepare the flow path structure 100b by simply covering and sealing the flow path with a single flat plate, which has been processed on the side surface and the bottom surface, and thus, the preparing cost becomes more economical, and it becomes possible to prepare the flow path structure 100b with higher precision. Alternatively, at least a part of the top surfaces of the flow paths included in the first flow path group 10, the second flow path group 20, and the third flow path group 30 may be included in a single plane (first plane), and among the bottom surfaces of the flow paths included in the first flow path group 10, the second flow path group 20, and the third flow path group 30, the bottom surface facing the top surface that is not included in at least the first plane may be included in a single plane (second plane) different from the first plane.

In at least one of the flow paths included in the second flow path group 20, the opening area of the second flow path group side merging opening 62b is preferably smaller than the opening area of the second flow path group side branch opening 52b, and in at least another one of the flow paths included in the second flow path group 20, the opening area of the second flow path group side branch opening 62b is preferably larger than the opening area of the second flow path group side branch opening 52b. That is, the second flow path group 20 preferably includes a flow path of which the flow path cross-sectional area increases from upstream to downstream and a flow path of which the flow path cross-sectional area decreases from upstream to downstream. As an example, a structure in which the flow path cross-sectional area of the j-th flow path included in the second flow path group 20 increases from upstream to downstream, and the flow path cross-sectional area of the (M−j+1)-th flow path included in the second flow path group 20 decreases from upstream to downstream is also preferable.

In addition, the flow path width and the flow path depth of the flow path included in the flow path structure 100b are preferably 5 μm or more. At least, the flow path width and the flow path depth may be 5 μm or more at a location where the flow path cross-sectional area is the smallest. That is, the flow path width and the flow path depth of the second flow path group side merging opening 62b are preferably 5 μm or more. In addition, the depth of the flow path included in the flow path structure 100b is preferably equal to or less than the width of the flow path. Further, the opening area of the flow path included in the flow path structure 100b is preferably 100 mm² or less.

In addition, it is preferable that the second flow path group 20 have a point symmetric shape with a midpoint between the branch portion 5b and the merging portion 6b as a center point. As an example, a value obtained by dividing the opening area of the opening connected to the j-th flow path included in the second flow path group 20 in the second flow path group side merging opening 62b by the opening area of the opening connected to the j-th flow path included in the second flow path group 20 in the second flow path group side branch opening 52b is preferably 0.5 times or more and 2.0 times or less, and more preferably 0.8 times or more and 1.2 times or less a value obtained by dividing the opening area of the opening connected to the (M−j+1)-th flow path included in the second flow path group 20 in the second flow path group side branch opening 52b by the opening area of the opening connected to the (M−j+1)-th flow path included in the second flow path group 20 in the second flow path group side merging opening 62b. It is most preferable that this value is 1.0 times.

In addition, in the flow path structure 100b according to the present embodiment, preferably, the opening area of the opening connected to the j-th flow path included in the second flow path group 20 in the second flow path group side branch opening 52b is 0.5 times or more and 2.0 times or less the opening area of the opening connected to the (M−j+1)-th flow path included in the second flow path group 20 in the second flow path group side branch opening 62b, or/and the opening area of the opening connected to the (M−j+1)-th flow path included in the second flow path group 20 in the second flow path group side branch opening 52b is preferably 0.5 times or more and 2.0 times or less the opening area of the opening connected to the j-th flow path included in the second flow path group 20 in the second flow path group side merging opening 62b. These values are more preferably 0.8 times or more and 1.2 times or less, and most preferably 1.0 times.

In addition, similar to the flow path structure 100 shown in FIG. 12, the flow path structure 100b may also have a structure in which, in at least some of the flow paths included in the first flow path group 10 or at least some of the flow paths included in the third flow path group 30, the shape of the cross section perpendicular to the tube axis direction of the flow paths continuously changes as approaching the first branch portion 5b.

Further, a plurality of the flow path structures 100b may be used as a fluid structure unit.

Note that the flow path structure 100b may further include a configuration such as an inlet 80 that allows two or more types of fluids to flow into at least one flow path included in the first flow path group 10.

### Fourth Embodiment

FIG. 21 is an example of a schematic view when using a combination of a plurality of flow path structures. In the present embodiment, a structure including flow path structures 110 and 120 having the same shape as the flow path structure 100 is defined as a flow path structure unit 300. Furthermore, in FIG. 21, an inlet 80 into which two types of fluids can flow toward the first flow path 1 is provided on the upstream side of the flow path structure 100. By connecting the plurality of the flow path structures to each other in this manner, a swirling flow can be repeatedly generated, and more rapid mixing of different types of liquids can be achieved. In addition, although not shown, the inlet 80 may have three or more inlets, and may have a structure capable of allowing three or more types of fluids to flow in.

Although the number of the flow path structures included in the flow path structure unit 300 shown in the drawing is three, the number of the flow path structures may be one, two, or four or more.

In addition, although an aspect in which a plurality of the flow path structures are connected to each other in series is shown in the drawing, a method for connecting the flow path structures to each other is not limited thereto, and a structure in which the flow path structures are connected to each other in parallel via the branch portion 5 or the like may be included.

In addition, since the inlet 80 in the drawing has two inflow ports, it is possible to allow two types of fluids to flow in, but the number of inflow ports and the number of types of liquids are not limited thereto. The inlet 80 may have three or more inflow ports and allow three or more types of liquids to flow in.

### Fourth Embodiment

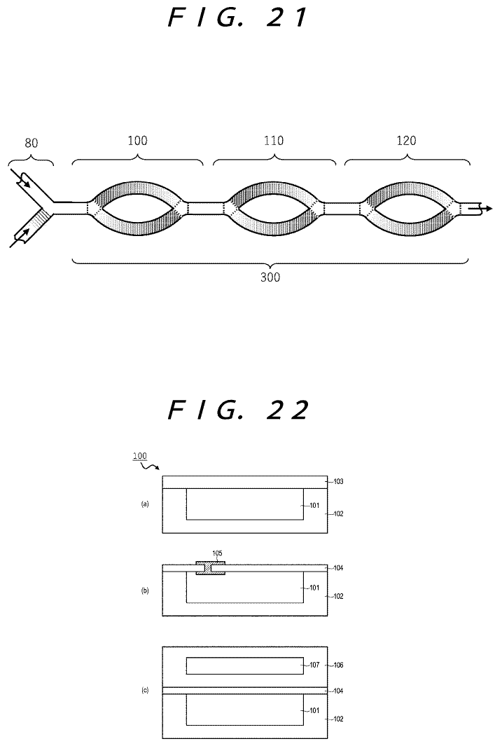

In the present embodiment, a method for producing the flow path structure (hereinafter collectively referred to as the “flow path structure 100”) described in the first to third embodiments will be described below with reference to FIG. 22. As shown in FIG. 22A, the flow path structure 100 includes, for example, a substrate 102 in which a groove 101 functioning as a flow path is formed, and a plate-like lid 103 joined to the substrate 102 to close the top surface of the groove 101.

The material of the substrate 102 may be appropriately selected from resins such as acrylic, polyethylene, polypropylene, and polycarbonate, glass, ceramics, metal, and the like according to the application. For example, when the flow path structure 100 is for medical use, a cycloolefin polymer (COP) or the like is also a preferred example. Ceramics such as glass and quartz are preferable from the viewpoint of stability when reused many times, and a metal having a surface subjected to a treatment for corrosion resistance may be used when the temperature and the like are adjusted. The groove 101 can be formed by press working or cutting using a mold, for example. In the location corresponding to the shallow portion, the groove 101 may be formed or cut shallower than other parts.

As the material of the lid 103, for example, the same material as that described for the substrate 102 can be used. The lid 103 may have, for example, a plate shape. Alternatively, as shown in FIG. 22B, a thin film-like lid 104 may be used.

It is also possible to attach a sensor terminal 105 for monitoring the state of the fluid to the film-like lid 104. Alternatively, it is also possible to impart various functions or characteristics such as high thermal conductivity or a function (not shown) of performing a specific treatment on a specific substance to the film-like lid 104.

When there is a concern that the film-like lid 104 may swell due to the internal pressure, as shown in FIG. 22C, the swell may be suppressed by pressing a pressing plate 106 from above the film-like lid 104. The pressing plate 106 may include a heat medium flow path 107 for heat exchange disposed therein, an electric terminal (not shown) having a sensor function, or the like.

Thus, the flow path structure 100 can be produced by a simple procedure in which the groove 101 is formed in the substrate 102 and the lid 103 or the film-like lid 104 is joined. Therefore, for example, it is unnecessary to form grooves in both the substrate 102 and the lid 103 and to precisely align the substrate 102 and the lid 103, and thus mass productivity is extremely high.

Further, the depth of the groove 101 at the location where the flow path depth becomes smaller may be set to the same depth as the other parts, and the film-like lid 104 of which the thickness changes depending on the position may be attached to the corresponding location to form a flow path of which the flow path depth changes. That is, in the flow path formed in this manner, the flow path depth changes as the thickness of the top surface changes depending on the position. Even in such a structure, highly uniform mixing can be realized as in a structure in which the shape of the bottom surface changes depending on the position.

### Fifth Embodiment

In the present embodiment, a fluid stirring method is provided. The fluid stirring method includes causing a fluid to be stirred to flow into the flow path structure 100 of the embodiment. According to the fluid stirring method, the fluid can be further mixed and stirred by using the flow path structure 100 of the embodiment.

In the case of using the flow path structure 100 of the first to fourth embodiments, the present method includes causing a fluid to flow from the first flow path 1 through the second flow path 2 or the third flow path 3 to the fourth flow path 4.

Furthermore, in the present method, the fluid flowing in the flow path may be two or more different types of fluids, and according to the flow path structure 100 of the first to fourth embodiments, these fluids can be mixed and stirred.

### Sixth Embodiment

In the present embodiment, a method for producing a lipid particle 200 encapsulating a drug 202 using the flow path structure 100 of the embodiment will be described.

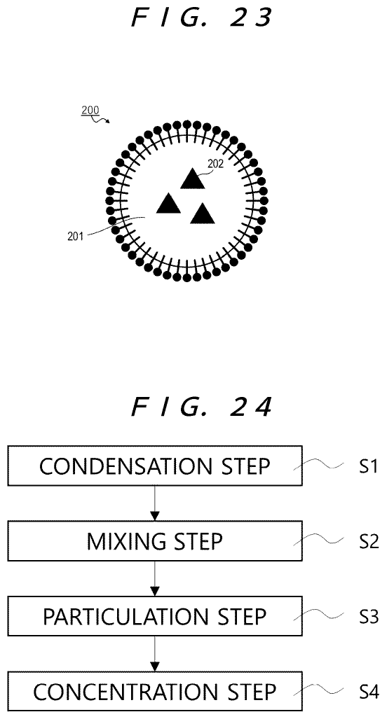

First, the lipid particle 200 produced by the present method will be described. As shown in FIG. 23, the lipid particle 200 includes a lipid membrane formed by arranging lipid molecules, and has a substantially hollow spherical shape. The drug 202 is encapsulated in a lumen 201 of the lipid particle 200. The lipid particles 200 may be used, for example, to deliver the drug 202 into cells.

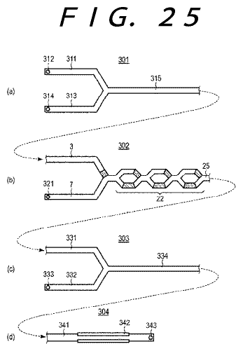

FIG. 24 is a flowchart showing an example of a method for producing the lipid particle 200. The method for producing the lipid particle 200 includes: a step of condensing the drug 202 (in the case of a nucleic acid) (condensation step S1); a step of causing a first solution encapsulating a lipid of a material of the lipid particle 200 to flow into an organic solvent from one of inflow ports (first inflow port) positioned on the upstream side of the first flow path 1 and causing a second solution encapsulating the drug 202 to flow into an aqueous solvent from another inflow port (second inflow port) positioned on the upstream side of the first flow path 1 using the flow path structure 100 of the embodiment to mix the first solution and the second solution to obtain a mixed solution (mixing step S2); a step of particulating the lipid and generating the lipid particle 200 encapsulating the drug 202 by reducing the concentration of the organic solvent in the mixed solution (particulation step S3); and a step of concentrating the lipid particle 200 solution (concentration step S4). The present producing method can be performed using, for example, a flow path structure shown in FIG. 25. FIG. 25A shows an aggregation flow path structure 301 having a configuration for performing a condensation step S1, FIG. 25B shows a flow path structure 302 of an embodiment for performing a mixing step S2, FIG. 25C shows a particulation flow path structure 303 having a configuration for performing a particulation step S3, and FIG. 25D shows a concentration flow path structure 304 having a configuration for performing a concentration step S4.

Hereinafter, an example of a procedure of the present producing method will be described.

First, the first solution and the second solution are prepared. The first solution contains a lipid in an organic solvent. The lipid is a lipid to be a material constituting the lipid particle 200. The second solution contains the drug 202 in an aqueous solvent.

### Condensation Step S1

The drug 202 is, for example, but not limited to, a nucleic acid. The nucleic acid drug 202 is, for example, a nucleic acid containing DNA, RNA, and/or other nucleotides, and may be, for example, mRNA of a specific gene, DNA encoding a gene, DNA containing a gene expression cassette containing a gene and other sequences for expressing a gene such as a promoter, a vector, or the like. When the drug 202 is a nucleic acid, the aggregation step S1 of aggregating the nucleic acid (drug 202) may be first performed.

The condensation of the nucleic acid is performed using, for example, a nucleic acid condensing peptide. The nucleic acid condensing peptide can further reduce the particle size of the lipid particle 200 by condensing the nucleic acid into a small size, and can encapsulate more nucleic acid in the lipid particle 200. As a result, less nucleic acid may remain outside the lipid particle 200 that may cause aggregation of the lipid particle 200.

A preferred nucleic acid condensing peptide is, for example, a peptide containing 45% or more cationic amino acids as a whole. A more preferred nucleic acid condensing peptide has RRRRRR (first amino acid sequence) at one end and has the sequence ROROR (second amino acid sequence) at the other end. Between the first amino acid sequence and the second amino acid sequence, 0 or 1 or more intermediate sequences consisting of RRRRRR or RORQR are included. In addition, two or more neutral amino acids are contained between two adjacent sequences among the first amino acid sequence, the second amino acid sequence, and the intermediate sequence. The neutral amino acid is, for example, G or Y. The other end may have RRRRRR (first amino acid sequence) instead of the second amino acid sequence.

The nucleic acid condensing peptide preferably has the following amino acid sequence:

(SEQ ID NO: 1)
RQRQRYYRQRQRGGRRRRRR
(SEQ ID NO: 2)
RQRQRGGRRRRRR
(SEQ ID NO: 3)
RRRRRRYYRQRQRGGRRRRRR.

Furthermore, a nucleic acid condensing peptide having the following amino acid sequence can also be used in combination with any of the nucleic acid condensing peptides described above. This peptide can further condense the nucleic acid condensate condensed with the nucleic acid condensing peptide.

(SEQ ID NO: 4)
GNQSSNFGPMKGGNFGGRSSGPYGGGGQYFAKPRNQGGY (M9)

As shown in FIG. 25A, the aggregation flow path structure 301 for performing the aggregation step S1 is, for example, a Y-like flow path. At the upstream end of one of the Y-shaped branched flow paths 311, for example, an aggregating agent inflow port 312 is provided, from which an aggregating agent containing a nucleic acid condensing peptide is allowed to flow. A drug inflow port 314 is provided at an upstream end of the other flow path 313, and a solution containing a nucleic acid (drug 202) in an aqueous solvent flows from the drug inflow port. The aqueous solvent is, for example, water, saline such as physiological saline, glycine aqueous solution, buffer solution, or the like. As a result, the solution containing the condensing agent and the drug 202 is mixed in the flow path 315 where the flow path 311 and the flow path 313 merge. Mixing results in a second solution containing the condensed drug 202.

The condensation step S1 is not necessarily performed using a flow path, and the aggregating agent and the solution containing the nucleic acid (drug 202) in the aqueous solvent may be mixed and stirred.

From the viewpoint of achieving the above effect, it is preferable to perform the condensation step S1 when the drug 202 is a nucleic acid. However, when the drug 202 is not a nucleic acid, or when the drug is a nucleic acid but does not need to be condensed, it is not necessary to perform the condensation step S1.

### Mixing Step S2

Next, the first solution and the second solution are mixed. The second solution may be prepared as described above when the drug 202 is a nucleic acid. Alternatively, when the nucleic acid that does not condense or the drug 202 that is not a nucleic acid is used, the second solution can be prepared by mixing the drug 202 with any of the aqueous solvents selected according to the type thereof. The drug 202 that is not a nucleic acid includes, for example, a protein, a peptide, an amino acid, another organic compound, an inorganic compound, or the like as an active component. The drug 202 may be, for example, a therapeutic agent or diagnostic agent for a disease. However, the drug 202 is not limited thereto, and may be any substance as long as the drug 202 can be encapsulated in the lipid particle 200.

If necessary, the drug 202 may further contain a reagent such as, for example, a pH adjusting agent, an osmotic pressure adjusting agent, and/or a drug activating agent. The pH adjusting agent is, for example, an organic acid such as citric acid and a salt thereof. The osmotic pressure adjusting agent is a sugar, an amino acid, or the like. The drug activating agent is, for example, a reagent that assists the activity of the active ingredient. These may be added after the condensation step S1 is performed.

The drug 202 may be a single substance or may contain a plurality of substances. The concentration of the drug 202 in the second solution is preferably, for example, 0.01% to 1.0% (weight).

The first solution can be produced by mixing a lipid and an organic solvent. The lipid may be, for example, a lipid of a main component of a biological membrane. The lipid may be artificially synthesized. The lipid can include, for example, a base lipid such as a phospholipid or a sphingolipid, for example, diacylphosphatidylcholine, diacylphosphatidylethanolamine, ceramide, sphingomyelin, dihydrosphingomyelin, cephalin, or cerebroside, or a combination thereof.

For example, as base lipids,
it is preferable to use 1,2-dioleoyl-sn-glycero-3-phosphoethanolamine (DOPE),
1,2-stearoyl-sn-glycero-3-phosphoethanolamine (DSPE),
1,2-dipalmitoyl-sn-glycero-3-phosphatidylcholine (DPPC),
1-palmitoyl-2-oleoyl-sn-glycero-3-phosphatidylcholine (POPC),
1,2-di-O-octadecyl-3-trimethylammoniumpropane (DOTMA),
1,2-dioleoyl-3-dimethylammoniumpropane (DODAP),
1,2-dimyristoyl-3-dimethylammoniumpropane (14:0 DAP),
1,2-dipalmitoyl-3-dimethylammoniumpropane (16:0 DAP),
1,2-distearoyl-3-dimethylammoniumpropane (18:0 DAP),
N-(4-carboxybenzyl)-N, N-dimethyl-2,3-bis(oleoyloxy) propane (DOBAQ),
1,2-dioleoyl-3-trimethylammoniumpropane (DOTAP),
1,2-dioleoyl-sn-glycero-3-phosphochlorin (DOPC),
1,2-dilinoleoyl-sn-glycero-3-phosphochlorin (DLPC),
1,2-dioleoyl-sn-glycero-3 phospho-L-serine (DOPS), or cholesterol,
cholesterol, or a combination of any of these. In particular, it is preferable to use DOTAP and/or DOPE.

The lipid preferably further includes a first lipid compound and/or a second lipid compound that are biodegradable lipids. The first lipid compound can be represented by the formula Q-CHR₂.

In the formula,
Q is a nitrogen-containing aliphatic group containing two or more tertiary nitrogen atoms and no oxygen,
R is each independently an aliphatic group of C₁₂ to C₂₄, and
at least one R contains, in the main chain or side chain, a linking group LR selected from the group consisting of —C(═O)—O—, —O—C(═O)—, —O—C(═O)—O—, —S—C(═O)—, —C(═O)—S—, —C(═O)—NH—, and —NHC(═O).

The first lipid compound is, for example, a lipid having a structure represented by the following formulas.

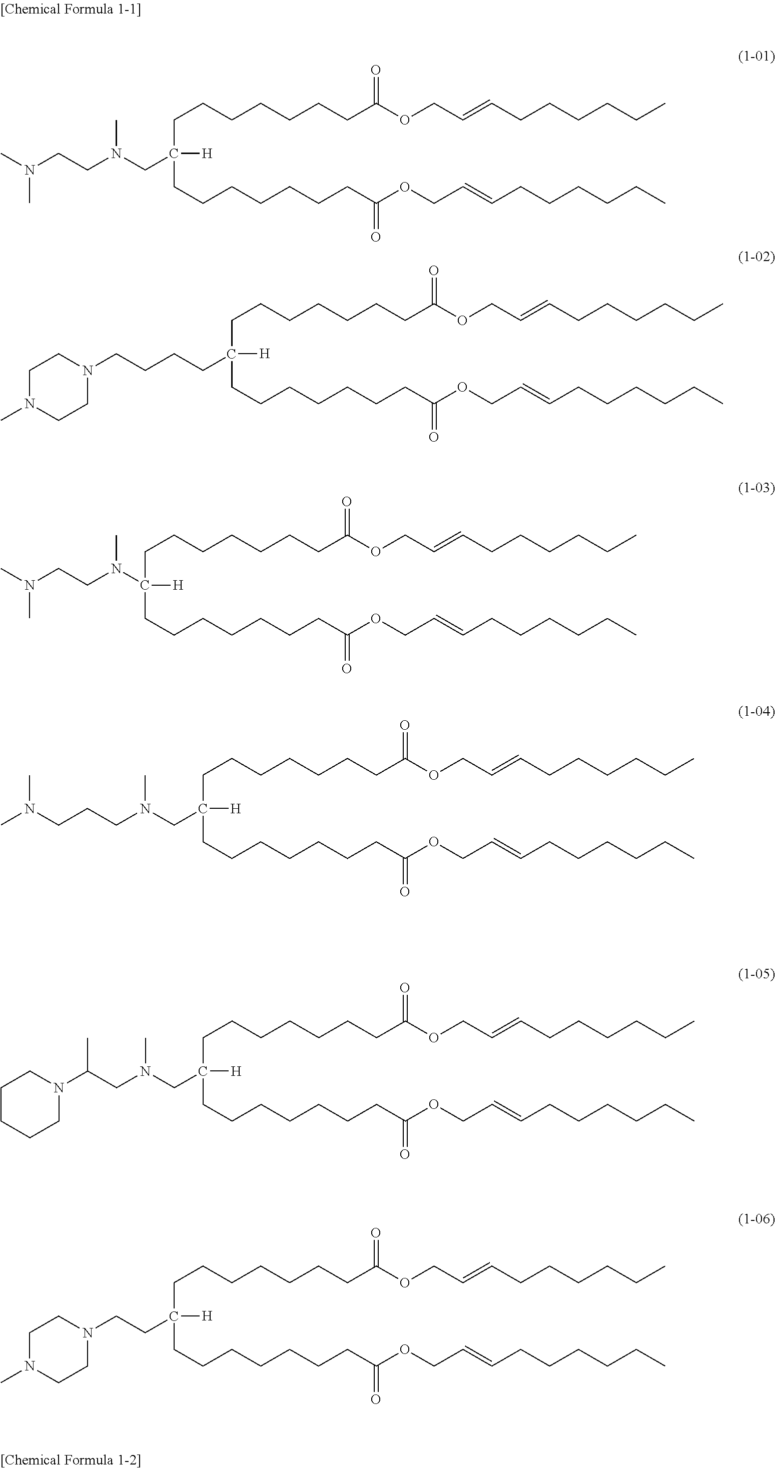

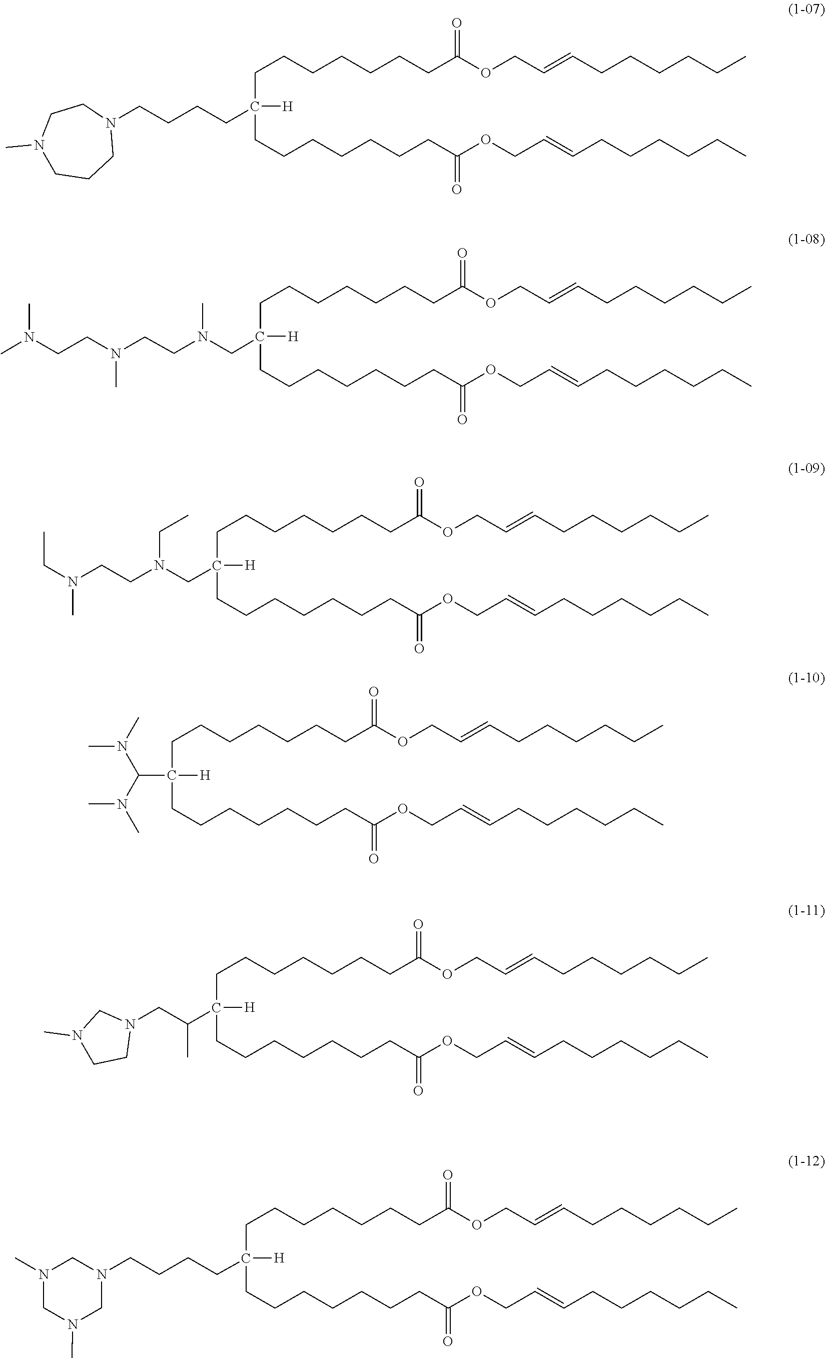

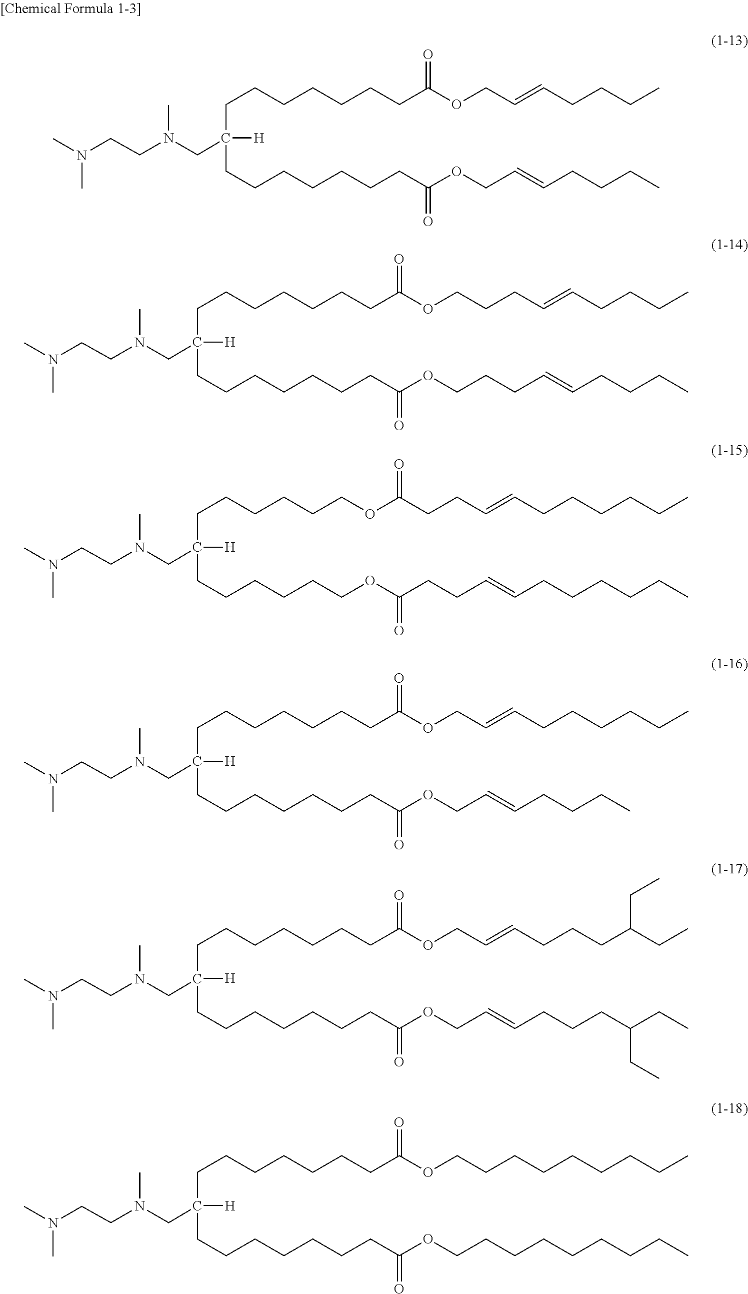

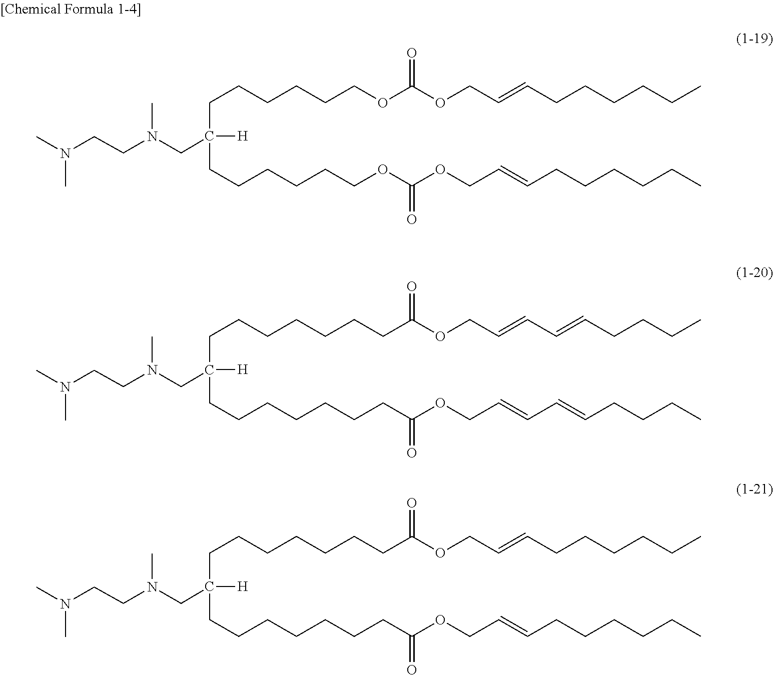

In particular, it is preferable to use a lipid compound of Formula (1-01) and/or a lipid compound of Formula (1-02).

The second lipid compound can be represented by the formula

P—[X—W—Y—W′—Z]₂.

In the formula,
P is an alkyleneoxy containing one or more ether bonds in the main chain,
X is each independently a divalent linking group containing a tertiary amine structure,
W is each independently a C₁ to C₆ alkylene,
Y is each independently a divalent linking group selected from the group consisting of a single bond, an ether bond, a carboxylic acid ester bond, a thiocarboxylic acid ester bond, a thioester bond, an amide bond, a carbamate bond, and a urea bond,
W′ is each independently a single bond or a C₁ to C₆ alkylene, and
Z is each independently a fat-soluble vitamin residue, a sterol residue, or a C₁₂ to C₂₂ aliphatic hydrocarbon group.

The second lipid compound is, for example, a lipid having a structure represented by the following formulas.

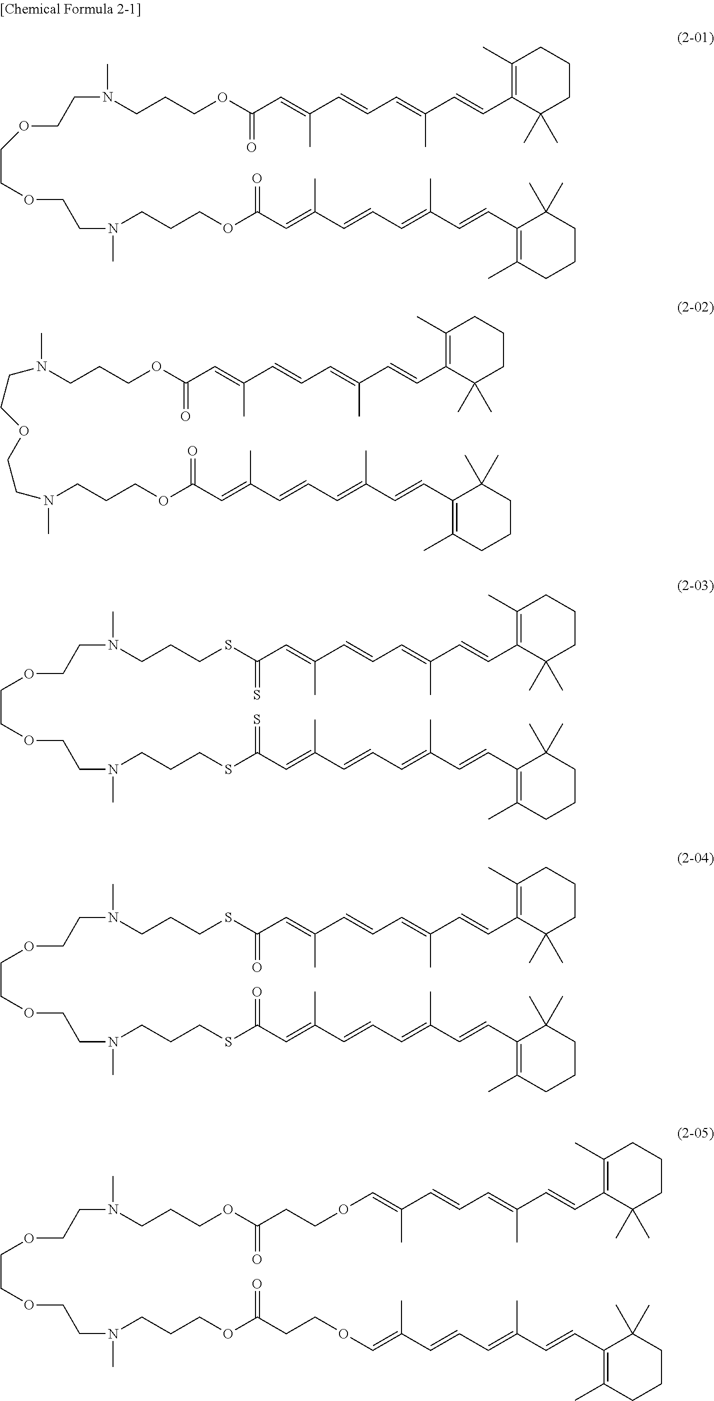

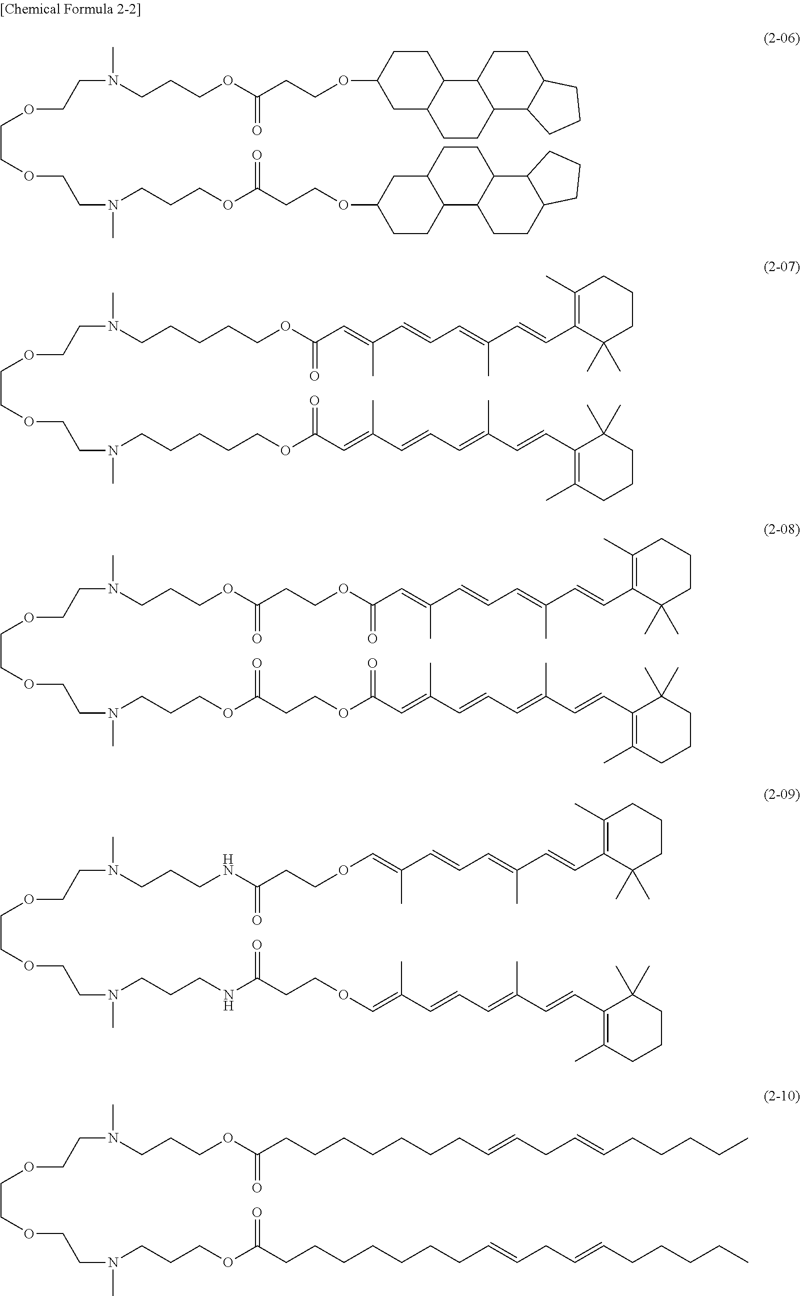

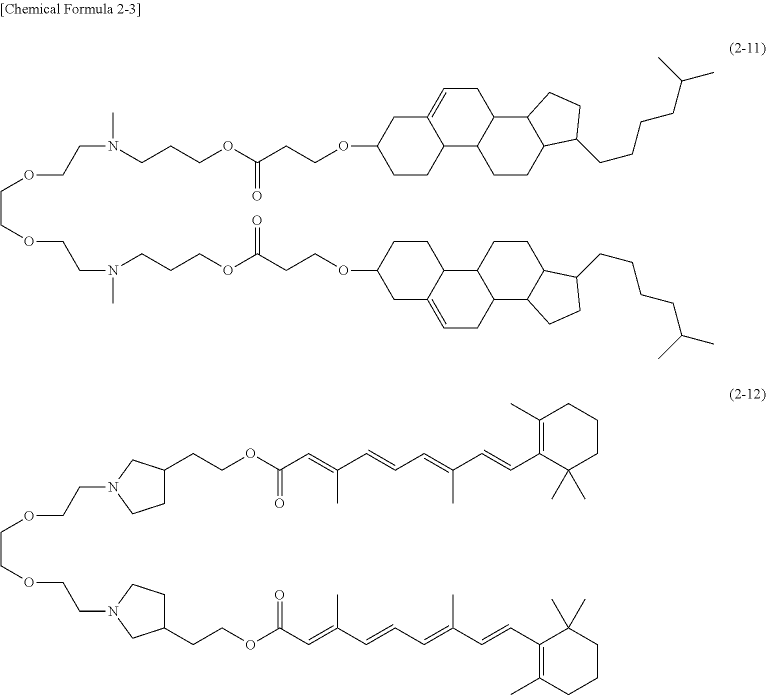 [SMILES: CC(C)CCCCC1CCC2C1CCC1C3CCC(OCCC(=O)OCCCN(C)CCOCCOCCN(C)CCCOC(=O)CCOC4CCC5C(=CCC6C5CCC5C(CCCCC(C)C)CCC56)C4)CC3=CCC12 ; CC1=C(/C=C/C(C)=C/C=C/C(C)=C/C(=O)OCCC2CCN(CCOCCOCCN3CCC(CCOC(=O)/C=C(C)/C=C/C=C(C)/C=C/C4=C(C)CCCC4(C)C)C3)C2)C(C)(C)CCC1]

In particular, it is preferable to use a compound of Formula (2-01).

When the first lipid compound and the second lipid compound are contained, it is possible to increase the encapsulation amount of the drug 202 in the lipid particle 200 and to increase the introduction efficiency of the drug 202 into cells. In addition, cell death of the introduced cells can also be reduced.

The base lipid is preferably contained in an amount of 30% to approximately 80% (molar ratio) with respect to the total lipid material. Alternatively, nearly 100% may be composed of base lipids. The first and second lipid compounds are preferably contained in an amount of approximately 20% to approximately 70% (molar ratio) with respect to the total lipid material.

It is also preferable that the lipid contain a lipid that prevents aggregation of the lipid particles 200. For example, the lipid that prevents aggregation preferably further includes lipid, a PEG-modified for example, polyethylene glycol (PEG) dimyristoyl glycerol (DMG-PEG), a polyamide oligomer (U.S. Pat. No. 6,320,017) derived from an omega-amino (oligoethylene glycol) alkanoic acid monomer, monosialoganglioside, or the like. Such a lipid is preferably contained in an amount of approximately 1% to approximately 10% (molar ratio) with respect to the entire lipid material of the lipid particle 200.

The lipid may further include a lipid such as a relatively less toxic lipid for modulating toxicity, a lipid having a functional group that binds ligands to the lipid particle 200, and a lipid for suppressing leakage of an encapsulated substance such as sterol, for example, cholesterol. In particular, it is preferable to contain cholesterol.

For example, the lipid particle 200 preferably contains a compound of Formula (1-01) or Formula (1-02) and/or a compound of Formula (2-01), DOPE and/or DOTAP, cholesterol, and DMG-PEG.

The type and composition of the lipid are appropriately selected in consideration of the target acid dissociation constant (pKa) of the lipid particle 200 or the size of the lipid particle 200, the type of the encapsulated substance, stability in the cell to be introduced, and the like. For example, in order to obtain a desired composition of lipids constituting the lipid particle 200, the composition of lipids contained in the first solution may be set to the same ratio.

The organic solvent of the first solution is, for example, ethanol, methanol, isopropyl alcohol, ether, chloroform, benzene, acetone, or the like. The concentration of the lipid in the organic solvent is preferably, for example, 0.1% to 0.5% (weight).

The first solution and the second solution are mixed using the flow path structure 302 of the embodiment as shown in FIG. 25B. Here, as the flow path structure 302, the flow path structures 110 and 120 having the same shape as that of the flow path structure 100 are connected to each other in series similar to the third embodiment to form the flow path structure unit 300, but the flow path structure 302 is not limited thereto.

When the aggregation step S1 is performed, the downstream end of the flow path 315 of the aggregation flow path structure 301 is connected to one end of the inlet 80 of the flow path structure 302 of the embodiment, and the second solution is supplied therefrom. When the condensation step S1 is not performed, a second solution inflow port (not shown) is provided at one end upstream of the inlet 80, and the second solution is supplied therefrom. The other upstream end of the inlet 80 includes, for example, a first solution inflow port 321 at the upstream end thereof, and the first solution is supplied therefrom. As a result, the first solution and the second solution are mixed to obtain a mixed solution. When the flow path structure unit 300 is provided, the mixed solution is further mixed and stirred therein. For example, when the condensation step S1 is not performed, the first solution may be caused to flow to one upstream end of the inlet 80, and the second solution may be caused to flow to the first solution inflow port 321.

### Particulation Step S3

Next, in the particulation step S3, the concentration of the organic solvent in the mixed solution is reduced. For example, it is preferable to relatively reduce the organic solvent concentration by adding a large amount of the aqueous solution to the mixed solution. For example, three times the amount of the aqueous solution of the mixed solution is added to the mixed solution. As the aqueous solution, the same aqueous solvent as that used for the first solution can be used. By reducing the organic solvent concentration, the lipid can be particulated, and the lipid particle 200 encapsulating the drug 202 can be generated. As a result, a lipid particle solution containing the lipid particles 200 is obtained.

As shown in FIG. 25C, the particulation flow path structure 303 that performs the particulation step S3 is, for example, a Y-like flow path. An upstream end of one of the flow paths 331 branched in a Y shape is connected to, for example, the most downstream end (in this example, the fourth flow path 4) of the flow path structure 302, and the mixed solution is supplied therefrom. The upstream end of the other flow path 332 includes, for example, an aqueous solution inflow port 333, and the aqueous solution flows therefrom. As a result, the aqueous solution is mixed with the mixed solution in the flow path 334 where the flow path 331 and the flow path 332 merge. As a result, the lipid is particulated, the lipid particle 200 encapsulating the drug 202 is generated, and a lipid particle solution containing the lipid particle 200 is obtained.

The particulation step S3 is not necessarily performed using a flow path, and for example, an aqueous solution may be added to the mixed solution recovered in the container.

In this manner, the lipid particle 200 can be produced.

### Concentration Step S4

The method for producing a lipid particle of the embodiment may further include concentrating the lipid particle solution as necessary (concentration step S4). The concentration is performed, for example, by removing a part of the solvent and/or excess lipid and the drug 202 from the lipid particle solution. The concentration can be performed, for example, by ultrafiltration. For ultrafiltration, for example, an ultrafiltration filter having a pore diameter of 2 nm to 100 nm is preferably used. For example, Amicon (registered trademark) Ultra-15 (Merck) or the like can be used as the filter. By performing the concentration step S4, a lipid particle solution having high purity and concentration can be obtained. The concentration of the lipid particles 200 in the lipid particle solution after concentration is preferably approximately 1×10¹³ particles/mL to 5×10¹³ particles/mL. However, the concentration step S4 is not necessarily performed.

As shown in FIG. 25D, the concentration flow path structure 304 that performs the concentration step S4 includes a flow path 341 and a filter 342 provided on a wall surface of the flow path 341. An upstream end of the flow path 341 is connected to, for example, the flow path 334 of the particulation flow path structure 303.

The filter 342 is provided instead of, for example, a partial wall surface of the flow path 341. Any of the ultrafiltration filters described above can be used as the filter 342.

When the lipid particle solution flows into the flow path 341, the remaining material, the extra solvent, and the like pass through the filter 342 and are discharged to the outside of the flow path 341, the lipid particles 200 remain in the flow path 341 and flow downstream, and accordingly, the lipid particle solution is concentrated. The downstream end of the flow path 341 may include a discharge port 343 for recovering the lipid particle solution after concentration, or may be connected to a tank for recovering the lipid particle solution.

The concentration step S4 is not necessarily performed using a flow path, and for example, the lipid particle solution recovered in the container may be filtered by a filter.

In addition, in the method for producing a lipid particle of the embodiment, a treatment for improving the quality of the lipid particle 200 may be further performed as necessary. The improvement in quality can be, for example, prevention of leakage of the drug 202 from the lipid particles 200, improvement in the encapsulation amount of the drug 202 in the lipid particles 200, improvement in the ratio (encapsulation rate) of the lipid particles 200 encapsulating the drug 202, reduction and prevention of aggregation of the lipid particles 200, and/or reduction in variation in the size of the lipid particles 200. For example, a treatment for cooling the lipid particle solution may be performed. Such treatment may also be performed using a flow path.

Each of the above-described flow paths is, for example, a micro flow path. The flow of the fluid in the flow path, the injection of the fluid into the flow path, the extraction of the fluid from the tank, and/or the accommodation of the lipid particle solution into the container can be performed by, for example, a pump or an extrusion mechanism configured and controlled to automatically perform these operations.

The method for producing a lipid particle of the embodiment does not necessarily need to perform the condensation step S1 and the concentration step S4 as described above, and may include at least the mixing step S2 and the particulation step S3.

According to the method for producing lipid particles of the embodiment, since the mixing step S2 is performed using the flow path structure of the embodiment, the first solution and the second solution can be uniformly and well mixed and stirred, and it is possible to produce the lipid particles 200 with higher quality. For example, effects such as improvement of the encapsulation amount of the drug 202, reduction of the average particle diameter of the lipid particles 200, and improvement of the ratio of the lipid particles 200 encapsulating the drug 202 can be obtained.

In addition, in the production of the quality particles described in the present specification, the flow path structure 100b shown in the third embodiment may be used.

Although the embodiments of the present invention have been described above, these embodiments are presented as examples, and are not intended to limit the scope of the invention. These novel embodiments can be implemented in various other aspects, and various omissions, substitutions, and changes can be made without departing from the gist of the invention. These embodiments are included in the scope and gist of the invention and are included in the invention described in the claims and the equivalent scope thereof.

In addition, in the present specification, it has been described that the tube axis direction and the direction of the main flow of the flow path structure are as indicated by arrows in FIG. 1, but the tube axis direction and the direction of the main flow of the flow path structure are not limited thereto.

In addition, the “tube axis” described in the present specification may be, for example, a central axis of a flow path. However, this definition does not limit the interpretation of “tube axis” in a narrow sense, and should be interpreted as appropriate without impairing the gist of the invention described in the embodiment.

In addition, the embodiments and modifications described in the present specification can be combined in any manner.

Furthermore, the present disclosure includes examples according to the following supplementary notes.

### [Supplementary Note 1]

A flow path structure including:
a first flow path group including one or more flow paths;
a second flow path group connected to the first flow path group via a branch portion, the second flow path group including two or more flow paths;
a third flow path group connected to the second flow path group via a merging portion, the third flow path group including one or more flow paths;
the branch portion including a first flow path group side branch opening connected to an end of the flow path included in the first flow path group, the end being close to the second flow path group, and a second flow path group side branch opening connected to an end of the flow path included in the second flow path group, the end being close to the first flow path group; and
the merging portion including a second flow path group side branch opening connected to an end of the second flow path group, the end being close to the third flow path group, and a third flow path group side branch opening connected to an end of the third flow path group, the end being close to the second flow path group, wherein
when the first flow path group includes N flow paths,
the second flow path group includes M flow paths, and
M is N or more,
a sum of opening areas of the second flow path group side branch openings is equal to or less than M/N times a sum of opening areas of the first flow path group side branch openings, and
an opening area of at least one of the second flow path group side merging openings is equal to or smaller than an opening area of at least one of the third flow path group side merging openings.

### [Supplementary Note 2]

The flow path structure according to supplementary note 1, in which
an opening area of at least one of the second flow path group side branch openings is equal to or smaller than an opening area of at least one of the first flow path group side branch openings.

[Supplementary Note 3]

The flow path structure according to supplementary note 1 or 2, in which
at least some of the flow paths included in the second flow path group has a structure in which a shape of a cross section perpendicular to a tube axis direction of the flow path continuously changes.

[Supplementary Note 4]

The flow path structure according to any one of supplementary notes 1 to 3, in which
at least some of the flow paths included in the second flow path group has a structure in which a flow path depth continuously changes.

[Supplementary Note 5]

The flow path structure according to any one of supplementary notes 1 to 4, in which
at least some of the flow paths included in the second flow path group has a structure in which a flow path width continuously changes.

### [Supplementary Note 6]

The flow path structure according to any one of supplementary notes 1 to 5, in which
a top surface of flow paths included in the first flow path group, the second flow path group, and the third flow path group is included in a single plane.

### [Supplementary Note 7]

The flow path structure according to any one of supplementary notes 1 to 6, in which
at least a part of top surfaces of the flow paths included in the first flow path group, the second flow path group, and the third flow path group is included in a first plane, and
among bottom surfaces of the flow paths included in the first flow path group, the second flow path group, and the third flow path group, a bottom surface facing a top surface that is not included in at least the first plane is included in a second plane different from the first plane.

### [Supplementary Note 8]

The flow path structure according to any one of supplementary notes 1 to 7, in which
in at least one of the flow paths included in the second flow path group, an opening area of the second flow path group side merging opening is smaller than an opening area of the second flow path group side branch opening.

### [Supplementary Note 9]

The flow path structure according to any one of supplementary notes 1 to 8, in which
in at least one of the flow paths included in the second flow path group, an opening area of the second flow path group side merging opening is larger than an opening area of the second flow path group side branch opening.

### [Supplementary Note 10]

The flow path structure according to any one of supplementary notes 1 to 9, in which
a flow path width and a flow path depth of the second flow path group side merging opening are 5 μm or more.

### [Supplementary Note 11]

The flow path structure according to any one of supplementary notes 1 to 10, in which
the second flow path group has an approximately point symmetric shape with a midpoint between the branch portion and the merging portion as a center point.

### [Supplementary Note 12]

The flow path structure according to any one of supplementary notes 1 to 11, in which
a depth of a flow path included in the flow path structure is equal to or less than a width of the flow path.

### [Supplementary Note 13]

The flow path structure according to any one of supplementary notes 1 to 12, in which
an opening area of the flow path included in the flow path structure is 100 mm² or less.

### [Supplementary Note 14]

The flow path structure according to any one of supplementary notes 1 to 13, further including:
an inlet capable of allowing two or more types of fluids to flow into at least one flow path included in the first flow path group.

### [Supplementary Note 15]

The flow path structure according to any one of supplementary notes 1 to 16, in which
at least some of the flow paths included in the first flow path group or at least some of the flow paths included in the third flow path group has a structure in which a shape of a cross section perpendicular to a tube axis direction of the flow path continuously changes as approaching the first branch portion.

### [Supplementary Note 16]

A flow path structure including:
a first flow path;
a second flow path connected to the first flow path via a branch portion;
a third flow path connected to the first flow path via the branch portion;
a fourth flow path connected to the second flow path and the third flow path via a merging portion;
the branch portion including a first branch opening connected to an end of the first flow path, the end being close to the second flow path and the third flow path,
a second branch opening connected to an end of the second flow path, the end being close to the first flow path, and a third branch opening connected to an end of the third flow path, the end being close to the first flow path; and
the merging portion including a second merging opening connected to an end of the second flow path, the end being close to the fourth flow path, a third merging opening connected to an end of the third flow path, the end being close to the fourth flow path, and a fourth merging opening connected to an end of the fourth flow path, the end being close to the second flow path and the third flow path, wherein
a sum of opening areas of the second branch opening and the third branch opening is equal to or less than twice a sum of opening areas of the first branch opening, and
an opening area of at least one of the second merging opening and the third merging opening is equal to or smaller than an opening area of the fourth merging opening.

### [Supplementary Note 17]

A fluid structure unit including: a plurality of the flow path structures according to any one of supplementary notes 1 to 16.

### [Supplementary Note 18]

A method for producing a lipid particle encapsulating a drug using the flow path structure according to any one of supplementary notes 1 to 16, the method including:
a step of causing a first solution containing a lipid of a material of the lipid particle to flow into an organic solvent from a first inflow port positioned on an upstream side of the first flow path group and causing a second solution containing the drug to flow into an aqueous solvent from a second inflow port positioned on an upstream side of the first flow path group to mix the first solution and the second solution to obtain a mixed solution; and
a step of particulating the lipid and generating the lipid particle encapsulating the drug by reducing the concentration of the organic solvent in the mixed solution.

The embodiments have been described above with reference to the specific examples. However, embodiments are not limited to these specific examples. That is, those obtained as those skilled in the art appropriately apply a design change to these specific examples are also included in the scope of the embodiments, as long as they present the features of the embodiments. Each component included in each of the specific examples described above and its arrangement, a material, a condition, a shape, and a size, for example, are not limited to those exemplified, and may be appropriately changed.

In addition, it is possible to combine the components included in the embodiments described above, as far as it is technically possible. Such a combination is also included in the scope of the embodiments, as long as it presents the features of the embodiments. In addition, within the scope of the idea of the embodiments, a person skilled in the art is able to conceive various modifications and corrections. It is understood that the modifications and corrections also belong to the scope of the embodiments.

What is claimed is:

1. A flow path structure comprising:
a first flow path group including one or more flow paths;
a second flow path group connected to the first flow path group via a branch portion, the second flow path group including two or more flow paths;
a third flow path group connected to the second flow path group via a merging portion, the third flow path group including one or more flow paths;
the branch portion including a first flow path group side branch opening connected to an end of the flow path included in the first flow path group, the end being close to the second flow path group, and a second flow path group side branch opening connected to an end of the flow path included in the second flow path group, the end being close to the first flow path group; and
the merging portion including a second flow path group side branch opening connected to an end of the second flow path group, the end being close to the third flow path group, and a third flow path group side branch opening connected to an end of the third flow path group, the end being close to the second flow path group, wherein
when the first flow path group includes N flow paths,
the second flow path group includes M flow paths, and
M is N or more,
a sum of opening areas of the second flow path group side branch openings is equal to or less than M/N times a sum of opening areas of the first flow path group side branch openings, and
an opening area of at least one of the second flow path group side merging openings is equal to or smaller than an opening area of at least one of the third flow path group side merging openings.

2. The flow path structure according to claim 1, wherein
an opening area of at least one of the second flow path group side branch openings is equal to or smaller than an opening area of at least one of the first flow path group side branch openings.

3. The flow path structure according to claim 1, wherein
at least some of the flow paths included in the second flow path group has a structure in which a shape of a cross section perpendicular to a tube axis direction of the flow path continuously changes.

4. The flow path structure according to claim 3, wherein
at least some of the flow paths included in the second flow path group has a structure in which a flow path depth continuously changes.

5. The flow path structure according to claim 3, wherein
at least some of the flow paths included in the second flow path group has a structure in which a flow path width continuously changes.

6. The flow path structure according to claim 1, wherein
a top surface of flow paths included in the first flow path group, the second flow path group, and the third flow path group is included in a single plane.

7. The flow path structure according to claim 1, wherein
at least a part of top surfaces of the flow paths included in the first flow path group, the second flow path group, and the third flow path group is included in a first plane, and
among bottom surfaces of the flow paths included in the first flow path group, the second flow path group, and the third flow path group, a bottom surface facing a top surface that is not included in at least the first plane is included in a second plane different from the first plane.

8. The flow path structure according to claim 1, wherein
in at least one of the flow paths included in the second flow path group, an opening area of the second flow path group side merging opening is smaller than an opening area of the second flow path group side branch opening.

9. The flow path structure according to claim 8, wherein
in at least one of the flow paths included in the second flow path group, an opening area of the second flow path group side merging opening is larger than an opening area of the second flow path group side branch opening.

10. The flow path structure according to claim 1, wherein
a flow path width and a flow path depth of the second flow path group side merging opening are 5 μm or more.

11. The flow path structure according to claim 1, wherein
the second flow path group has an approximately point symmetric shape with a midpoint between the branch portion and the merging portion as a center point.

12. The flow path structure according to claim 1, wherein
a depth of a flow path included in the flow path structure is equal to or less than a width of the flow path.

13. The flow path structure according to claim 1, wherein
an opening area of the flow path included in the flow path structure is 100 mm² or less.

14. The flow path structure according to claim 1, further comprising:
an inlet capable of allowing two or more types of fluids to flow into at least one flow path included in the first flow path group.

15. The flow path structure according to claim 1, wherein
at least some of the flow paths included in the first flow path group or at least some of the flow paths included in the third flow path group has a structure in which a shape of a cross section perpendicular to a tube axis direction of the flow path continuously changes as approaching the first branch portion.

16. A flow path structure comprising:
a first flow path;
a second flow path connected to the first flow path via a branch portion;
a third flow path connected to the first flow path via the branch portion;
a fourth flow path connected to the second flow path and the third flow path via a merging portion;
the branch portion including a first branch opening connected to an end of the first flow path, the end being close to the second flow path and the third flow path, a second branch opening connected to an end of the second flow path, the end being close to the first flow path, and a third branch opening connected to an end of the third flow path, the end being close to the first flow path; and
the merging portion including a second merging opening connected to an end of the second flow path, the end being close to the fourth flow path, a third merging opening connected to an end of the third flow path, the end being close to the fourth flow path, and a fourth merging opening connected to an end of the fourth flow path, the end being close to the second flow path and the third flow path, wherein
a sum of opening areas of the second branch opening and the third branch opening is equal to or less than twice a sum of opening areas of the first branch opening, and
an opening area of at least one of the second merging opening and the third merging opening is equal to or smaller than an opening area of the fourth merging opening.

17. A fluid structure unit comprising:
a plurality of flow path structures according to claim 1.

18. A method for producing a lipid particle encapsulating a drug using the flow path structure according to claim 1, the method comprising:
a step of causing a first solution containing a lipid of a material of the lipid particle to flow into an organic solvent from a first inflow port positioned on an upstream side of the first flow path group and causing a second solution containing the drug to flow into an aqueous solvent from a second inflow port positioned on an upstream side of the first flow path group to mix the first solution and the second solution to obtain a mixed solution; and
a step of particulating the lipid and generating the lipid particle encapsulating the drug by reducing the concentration of the organic solvent in the mixed solution.
